(19) United States
(12) Patent Application Publication
(10) Pub. No.: US 2026/0252513 A1
(43) Pub. Date: Aug. 27, 2026

(54) SELF-CONFIGURABLE TRAFFIC GENERATOR AND METHOD THEREOF

(71) Applicant: SAMSUNG ELECTRONICS CO., LTD., Suwon-si (KR)

(72) Inventors: Sampathkumar M BALLARY, Bengaluru (IN); Aruna Shamsunder Lohiya, Bengaluru (IN); Vandana S, Bengaluru (IN); Ramesh Ganesh Patgar, Bengaluru (IN); Karthik Srinivasan, Bengaluru (IN)

(73) Assignee: SAMSUNG ELECTRONICS CO., LTD., Suwon-si (KR)

(21) Appl. No.: 19/547,217

(22) Filed: Feb. 23, 2026

(30) Foreign Application Priority Data
Feb. 21, 2025 (IN) 202541015131
Feb. 12, 2026 (IN) 202541015131

(51) Int. Cl. G06F 13/38

(52) U.S. Cl. CPC G06F 13/38

(57) ABSTRACT

A self-configurable traffic generator system in a System-on-Chip architecture includes a transmit special function register circuit configured to receive initial input parameters including frequency, expected bandwidth, periodicity, and latency from a silicon-dump or external target specification. A time-microscale circuit generates micro-level bandwidth targets based on one or more initial input parameters. A target-deviation circuit estimates, for each logical client, deviation between achieved bandwidth and corresponding micro-level bandwidth targets and computes adaptive weights using adaptive learning. A transactional-intelligence circuit controls one or more transaction parameters based on the adaptive weights. A transmit generation core circuit generates traffic for a plurality of clients based on the controlled one or more transaction parameters. A performance monitor circuit captures traffic information.

### CROSS-REFERENCE TO RELATED APPLICATION(S)

This application claims priority under 35 U.S.C. § 119 to and the benefit of Indian Provisional Application No. 202541015131, filed on Feb. 21, 2025, and Indian Patent Application No. 202541015131, filed on Feb. 12, 2026, in the Indian Intellectual Property Office, the disclosures of which are incorporated by reference herein in their entirety.

### BACKGROUND

### 1. Field

The disclosure relates to System-on-Chip (SoC) architecture validation, and more particularly to a self-configurable traffic generator system and a method for traffic generation in a SoC architecture.

### 2. Description of Related Art

Modern System-on-Chip (SoC) architectures have grown increasingly complex, incorporating tens of heterogeneous processing engines and memory controllers to meet demanding end-use case requirements. These SoC designs support a wide range of applications including large language models, high resolution and high frame rate cameras and displays, and 5G-based high bandwidth communication systems. Network-on-Chip (NoC) architectures and memory backbone designs form a central aspect of any SoC, providing the communication infrastructure that connects various intellectual property (IP) blocks integrated in the overall SoC space. As SoC complexity has increased, architecture validation and performance validation have become areas of focus to address post-silicon bottlenecks during the design process. Traffic generators play a role in SoC architecture validation and performance validation. The traffic generators stress the system bus and memory backbone at a pre-silicon stage by injecting traffic into the system. The traffic generators may measure the response while capturing statistics to measure deviation from ideal expectation or behavior. The traffic generators may be used as part of post-silicon debug to recreate various issues pertaining to performance and backbone architectures.

FIG. 1 is a block diagram of a traffic generation system 100, in accordance with a typical system. For example, the traffic generation system 100 may include a traffic generator 101 and a backbone 103. The traffic generator 101 may receive three input parameters, e.g., frequency (Freq), expected bandwidth (ExpBW), and periodicity. The Freq input may provide frequency information to the traffic generator 101. The ExpBW input may provide expected bandwidth information to the traffic generator 101. The Periodicity input may provide timing interval information to the traffic generator 101. The traffic generator 101 may communicate with the backbone 103 through three signal paths, e.g., a Tx Gen signal path, a Tx Acpt signal path, and a Tx Resp signal path. The Tx Gen signal path may carry generated transaction information from the traffic generator 101 to the backbone 103. The Tx Acpt signal path may carry transaction acceptance information from the backbone 103 back to the traffic generator 101. The Tx Resp signal path may carry transaction response information from the backbone 103 back to the traffic generator 101. The backbone 103 may represent the system interconnect infrastructure that receives traffic from the traffic generator 101 and may provide transaction acceptance and transaction response signals back to the traffic generator 101.

However, the traffic generation system 100 may exhibit a static traffic generation approach, in which the input parameters remain fixed once configured. The traffic generator 101 may lack the ability to dynamically adapt its behavior based on real-time system conditions or feedback from the backbone 103.

Hence, existing traffic generators may be static in nature. Once user requirements may be fixed, they may be used to stream traffic without the ability to change them over the course of time. Further, the existing traffic generators may require software intervention to configure a mode and traffic generation pattern. Furthermore, the existing traffic generators may not guarantee accurate reproduction of expected IP level behavior due to several variables in the SoC backbone infrastructure such as traffic from other masters. Such variables may be ad hoc in nature and contribute to the actual behavior of the traffic generator. Further, such variables may include patterns, such as transaction acceptance patterns and response rate patterns. Transaction acceptance patterns may result from factors including the number of masters interacting in the immediate next system interconnect and NoC bus backbone, maximum outstanding capability, priority amongst masters, buffer depths, and transient aspects of traffic across the NoC. These factors are dynamic in nature. Further, response rate patterns may result from factors including memory controller scheduling of memory access patterns and Dynamic Random Access Memory (DRAM) intrinsic limitations. The DRAM intrinsic limitations include self-refresh requirements, read-to-write requirements, read-to-read requirements, and write-to-write timing requirements. However, these variables prevent conventional traffic generators from achieving target bandwidths reliably.

Therefore, there is a need to provide improved techniques that overcome the above-mentioned and other related limitations.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

The disclosure relates to a self-configurable traffic generator for System-on-Chip (SoC) architecture validation. The traffic generator may achieve bandwidth targets adaptively using dynamic weight computation and transactional intelligence. The disclosure addresses limitations of static traffic generators that lack self-configurable capability and cannot adapt to real-time system behavior.

In an embodiment, the disclosure may provide a self-configurable traffic generator system in a System-on-Chip (SoC) architecture. The system may include a transmit special function register (SFR) circuit configured to receive one or more initial input parameters. The one or more initial input parameters include at least one of a frequency, an expected bandwidth, a periodicity, and a latency from at least one of a silicon-dump and an external target specification. The system may include a time-microscale circuit configured to generate micro-level bandwidth targets for traffic generation based on the one or more initial input parameters. The system may include a target-deviation circuit coupled to the time-microscale circuit. The target-deviation circuit may be configured to estimate, for each logical client, a deviation between an achieved bandwidth and a corresponding micro-level bandwidth target. The target-deviation circuit may be further configured to compute, for each logical client, adaptive weights using an adaptive learning technique. The system may further include a transactional-intelligence circuit coupled to the target-deviation circuit. The transactional-intelligence circuit may be configured to control one or more transaction parameters based on the adaptive weights. The one or more transaction parameters may include at least one of a transaction size, burst specifications, length parameters, transaction-issue rate with frequency scaling, a number of outstanding transactions, and issue-traffic patterns. The system may include a transmit generation core circuit configured to generate traffic for a plurality of clients based on the controlled one or more transaction parameters. The system may include a performance monitor circuit configured to capture traffic information.

In a further embodiment, the disclosure may provide a method for adaptive traffic generation in a System-on-Chip (SoC) architecture. The method may include receiving, by a transmit special function register (SFR) circuit, one or more initial input parameters. The one or more initial input parameters may include at least one of a frequency, an expected bandwidth, a periodicity, and a latency from a silicon-dump or an external target specification. The method may include generating, by a time-microscale circuit, micro-level bandwidth targets for traffic generation based on the one or more initial input parameters. The method may include monitoring, by a target-deviation circuit, real-time system behavior including at least one of transaction acceptance patterns and response-rate patterns. The method may include estimating, by the target-deviation circuit, a deviation between an achieved bandwidth and a corresponding micro-level bandwidth target for each logical client of the traffic. The method may include computing, by the target-deviation circuit, adaptive weights using an adaptive learning technique for each logical client. The method may include controlling, by a transactional-intelligence circuit, one or more transaction parameters based on the adaptive weights. The one or more transaction parameters may include at least one of a transaction size, burst specifications, length parameters, transaction-issue rate with frequency scaling, a number of outstanding transactions, and issue-traffic patterns. The method may include generating, by a transmit generation core circuit, traffic for a plurality of clients based on the controlled one or more transaction parameters. The method may include capturing, by a performance monitor circuit, traffic information.

In another embodiment, the disclosure may provide a traffic generator apparatus for validation of a System-on-Chip (SoC) architecture. The apparatus may include an input interface circuit configured to receive one or more configuration parameters comprising a timestamp-level bandwidth, a frequency, and latency information, from a silicon-dump or an external target specification source. The apparatus may include a target-generator circuit coupled to the input interface circuit and configured to generate micro-level bandwidth target based on the one or more configuration parameters. The apparatus may include a deviation circuit coupled to the target-generator circuit. The deviation circuit may be configured to monitor real-time system behavior including transaction acceptance patterns and response-rate patterns. The deviation circuit may be configured to estimate a deviation between an achieved bandwidth and a corresponding micro-level bandwidth target on a per-logical-client basis. The deviation circuit may be configured to compute adaptive weights using an adaptive learning technique. The apparatus may include an intelligence circuit coupled to the deviation circuit. The intelligence circuit may be configured to receive the adaptive weights. The intelligence circuit may be configured to control degrees of freedom comprising intra-transaction parameters, a transaction-issue rate, and inter-transaction parameters based on the adaptive weights. The intelligence circuit may be configured to output modified transaction parameters for traffic generation. The apparatus may include a traffic-generation core circuit coupled to the intelligence circuit and configured to generate traffic based on the modified transaction parameters. The apparatus may include a frequency-scaling circuit coupled to the intelligence circuit and configured to adjust a transaction frequency based on feedback from the intelligence circuit.

To further clarify the advantages and features of the disclosure, a more particular description of the disclosure will be rendered by reference to specific embodiments thereof, which are illustrated in the appended drawings. It is appreciated that these drawings depict only typical embodiments of the disclosure and are therefore not to be considered limiting to its scope. The disclosure will be described and explained with additional specificity and detail in the accompanying drawings.

### BRIEF DESCRIPTION OF DRAWINGS

These and other features, aspects, and advantages of the disclosure will be better understood when the following detailed description is read with reference to the accompanying drawings in which like characters represent like parts throughout the drawings, wherein:

FIG. 1 is a block diagram of traffic generation system, in accordance with a typical system;

FIG. 2 is a block diagram of a network architecture of a System on Chip (SoC) architecture, in accordance with an embodiment of the disclosure;

FIG. 3 is a block diagram of a system architecture for traffic generation and memory access, in accordance with an embodiment of the disclosure;

FIG. 4 is a block diagram of a self-configurable traffic generator system in the SoC architecture, in accordance with an embodiment of the disclosure;

FIG. 5 is a block diagram of a transmit generation core circuit, in accordance with an embodiment of the disclosure;

FIG. 6 is a block diagram of a transactional intelligence circuit, in accordance with an embodiment of the disclosure;

FIG. 7 is a working diagram of the transactional intelligence circuit operating on a per logical client basis, in accordance with an embodiment of the disclosure;

FIG. 8 is a block diagram of a system architecture with multiple traffic generators communicating via a hierarchical backbone, in accordance with an embodiment of the disclosure;

FIG. 9 is a block diagram of the self-configurable traffic generator system integrated in a block design for pre-silicon and post-silicon applications, in accordance with an embodiment of the disclosure;

FIG. 10 is a block diagram of traffic generator apparatus for validation of the SoC architecture, in accordance with an embodiment of the disclosure; and

FIG. 11 is a flowchart for a method for adaptive traffic generation in the SoC architecture, in accordance with an embodiment of the disclosure.

Further, it will be understood that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may be represented in the drawings by conventional symbols, and the drawings may show only those specific details that are pertinent to understanding the embodiments of the disclosure so as not to obscure the drawings with details that are readily apparent from the description herein.

### DETAILED DESCRIPTION

For the purpose of promoting an understanding of the principles of the disclosure, reference will now be made to the various embodiments, and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as part of the disclosure.

It will be understood that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the disclosure. Thus, appearances of the phrase “in an embodiment,” “in another embodiment” and similar language throughout this specification may, but do not necessarily, all refer to the same embodiment.

The terms “comprises”, “comprising”, or any other variations thereof, are intended to cover a non-exclusive inclusion, such that a process or method that includes a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

A self-configurable traffic generator for System-on-Chip (SoC) architecture validation addresses challenges associated with realistic traffic generation in complex semiconductor designs. Modern SoC architectures incorporate numerous heterogeneous processing engines and memory controllers interconnected through Network-on-Chip (NoC) backbone structures. Validation of such architectures requires traffic generators capable of stressing system interconnects and memory subsystems while accurately replicating expected behavior patterns.

Conventional traffic generators operate in a static manner, receiving fixed input parameters that remain unchanged throughout traffic generation operations. Such static approaches lack the ability to adapt to dynamic system conditions, including variations in transaction acceptance patterns, response latencies, and bandwidth availability caused by concurrent traffic from multiple masters. The SoC backbone infrastructure may be non-deterministic in nature from factors such as multi-master contention, priority scheduling, buffer depths, and transient traffic conditions. The non-deterministic nature of SoC backbone infrastructure prevents static traffic generators from achieving target bandwidth specifications with accuracy.

Accordingly, the disclosure may provide a self-configurable traffic generator to overcome the above-discussed and other related problems. The self-configurable traffic generator, hereinafter referred to as the traffic generator, may use adaptive learning techniques to compute dynamic weights on a per-logical-client basis. Accordingly, the traffic generator can adjust transaction parameters in response to real-time system behavior. The traffic generator may monitor transaction acceptance patterns and response-rate patterns from the system backbone and may estimate deviations between achieved bandwidth and target bandwidth specifications. Based on these deviations, the traffic generator computes adaptive weights that control transaction parameters including transaction size, burst specifications, length parameters, transaction-issue rate, and the number of outstanding transactions.

The traffic generator operates without external software intervention or external tuning agents, achieving target bandwidths through closed-loop adaptation of transaction parameters. When adjustment of transaction parameters proves insufficient to satisfy bandwidth targets, the traffic generator may request frequency scaling adjustments to modify the transaction-issue rate. This multi-level adaptation approach may enable the traffic generator to accommodate non-deterministic system behavior caused by memory controller scheduling, intrinsic dynamic random access memory timing constraints, and varying traffic conditions across the NoC backbone.

The traffic generator supports multiple logical clients, with each logical client receiving individually computed adaptive weights based on the respective bandwidth requirements and observed system behavior. This per-client adaptation may enable accurate modeling of traffic patterns from multiple masters with differing bandwidth and latency requirements. The traffic generator captures traffic information in a silicon-compatible format, thereby enabling use in both pre-silicon validation environments and post-silicon debug scenarios.

Embodiments of the disclosure will be described below in detail with reference to the accompanying drawings.

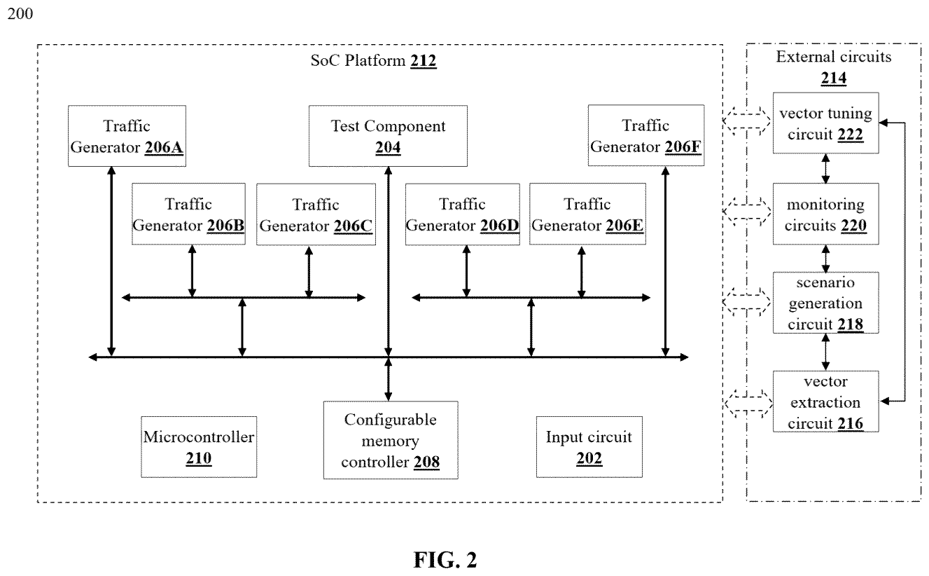

FIG. 2 is a network architecture of a System on Chip (SoC) 200, in accordance with an embodiment of the disclosure. The SoC 200 may be implemented as a platform (which is alternatively referred to as an SoC platform 212). The SoC platform 212 may be a simulation platform or an emulation platform. The SoC platform 212 may include an input circuit 202, a test component 204, a plurality of traffic generators 206A, 206B, 206C, 206D, 206E, and 206F (herein referred to as traffic generators 206), a configurable memory controller 208, and a microcontroller 210.

The input circuit 202 may receive configuration parameters and may provide the configuration parameters to the traffic generators 206 and other components in the SoC platform 212. The configuration parameters may include frequency specifications, expected bandwidth targets, periodicity values, and latency requirements that define the traffic generation behavior for each traffic generator. However, embodiments are not limited thereto.

The test component 204 may be positioned in the SoC platform 212 and may include the traffic generators 206B and 206C. The traffic generator 206A may be positioned at one end portion of the SoC platform 212, while the traffic generators 206D and 206E are positioned adjacent to the test component 204. The traffic generator 206F may be positioned near the boundary between the SoC platform 212 and the external circuits 214. The traffic generators 206A, 206B, 206C, 206D, 206E, and 206F may be interconnected via bidirectional communication paths that extend across the SoC platform 212, thereby enabling coordinated traffic generation and data exchange among the traffic generators 206. The test component 204 may communicate with other components through a Network on Chip (NoC).

The configurable memory controller 208 may be positioned between the microcontroller 210 and the input circuit 202. The configurable memory controller 208 may communicate with the traffic generators 206 through the interconnection paths and manages memory access operations for traffic generated by the traffic generators 206. The microcontroller 210 may provide control and coordination functions for the SoC platform 212.

In an embodiment, the SoC 200 may include one or more components, circuits, or modules. Some components, circuits, or modules may be connected internally to the SoC platform 212. Other components, circuits, or modules may be connected externally to the SoC platform 212, such as external circuits 214. The components, circuits, or modules may include electronic hardware components, software modules, or a combination thereof. The electronic hardware components may include processors, microcontrollers, memory devices, or specially configured electronic circuits. The software modules may include executable instructions stored in non-transitory computer-readable storage media and executable by one or more processors. The components, circuits, or modules may be general purpose components such as processors, microcontrollers, or may perform specific functions related to recreating silicon behavior of the SoC.

The external circuits 214 may include a vector extraction circuit 216, a scenario generation circuit 218, monitoring circuits 220, and a vector tuning circuit 222. The vector extraction circuit 216 may connect to the scenario generation circuit 218, which in turn connects to the monitoring circuits 220. The monitoring circuits 220 may be connected to the vector tuning circuit 222. The external circuits 214 may communicate with the SoC platform 212 through connections to the traffic generator 206F and the interconnection paths in the SoC platform 212.

The vector extraction circuit 216 may extract traffic vectors from silicon-dumps or simulation data for replay through the traffic generators 206. The scenario generation circuit 218 may generate traffic scenarios based on extracted vectors and target specifications. The monitoring circuits 220 may capture traffic information from the SoC platform 212, and may collect statistics associated with achieved bandwidth achieved, transaction acceptance rates, and transaction response latencies. The vector tuning circuit 222 may process feedback from the monitoring circuits 220 and may provide configuration data to enable adaptive traffic generation in the SoC 200.

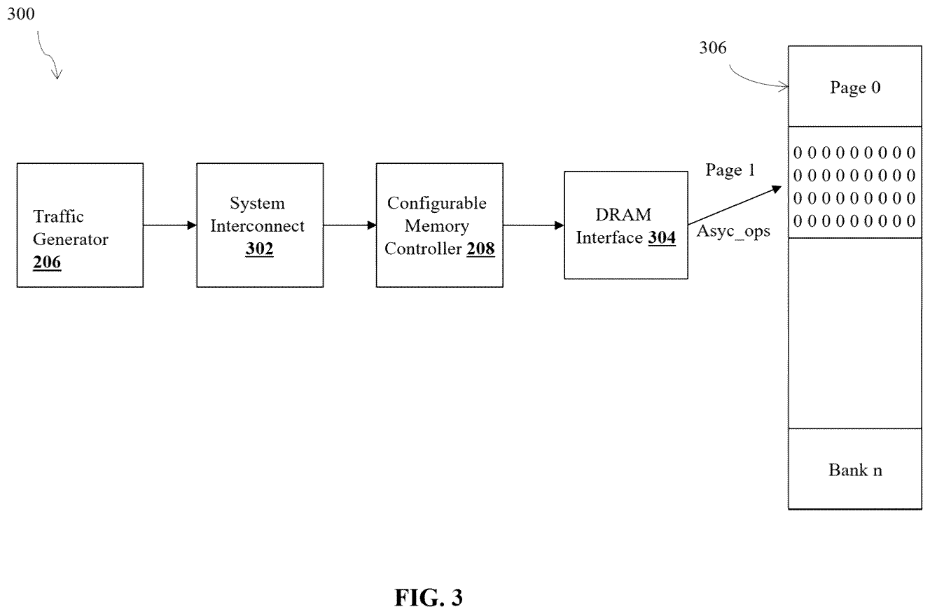

FIG. 3 is a block diagram of a system architecture 300 for traffic generation and memory access, in accordance with an embodiment of the disclosure. The system architecture 300 may include the traffic generators 206, a system interconnect 302, the configurable memory controller 208, a Dynamic Random Access Memory (DRAM) interface 304, and DRAM memory 306.

The traffic generators 206 may generate traffic that is transmitted to the system interconnect 302. The system interconnect 302 may route the traffic to the configurable memory controller 208, which manages memory access operations for transactions received from the traffic generators 206. The system interconnect 302 encompasses bus interconnect layers and routing logic that direct transactions from the traffic generators 206 to appropriate destination components in the system architecture 300.

The configurable memory controller 208 may communicate with the DRAM interface 304 through asynchronous operations. The asynchronous operations between the configurable memory controller 208 and the DRAM interface 304 may accommodate timing differences between the system interconnect domain and the memory domain. The configurable memory controller 208 may schedule memory access operations based on pending transactions, memory bank availability, and timing constraints imposed by the DRAM memory 306.

The DRAM interface 304 may provide access to the DRAM memory 306. The DRAM memory 306 may be organized into multiple pages including Page 0 and Page 1, and into multiple banks extending to Bank n. The DRAM memory 306 may store data in a structured format with rows of memory cells arranged in each page. The multi-bank organization of the DRAM memory 306 may enable concurrent access to different banks, subject to timing constraints and scheduling decisions made by the configurable memory controller 208.

The configurable memory controller 208 may implement scheduling patterns that determine the order and timing of memory access operations directed to the DRAM memory 306. The scheduling patterns may account for DRAM intrinsic limitations that impose timing constraints on consecutive memory operations. Self-refresh operations periodically interrupt normal memory access operations to maintain data integrity in the DRAM memory 306, thereby causing variations in response latency observed by the traffic generators 206. Read-to-write timing requirements may indicate a minimum interval between a read operation and a subsequent write operation to the same bank. Read-to-read timing requirements may indicate a minimum interval between consecutive read operations. Write-to-write timing requirements may indicate a minimum interval between consecutive write operations. These timing constraints may collectively influence the response-rate patterns experienced by the traffic generators 206.

In an embodiment, the traffic generators 206 adjusts transaction parameters responsive to response-rate variations caused by memory-controller scheduling and intrinsic DRAM timing requirements. The response-rate variations may arise from the scheduling patterns implemented by the configurable memory controller 208 and from the self-refresh, read-to-write, read-to-read, and write-to-write timing constraints imposed by the DRAM memory 306. The traffic generators 206 may monitor response latencies for transactions directed through the system interconnect 302 to the configurable memory controller 208 and may adapt transaction parameters to accommodate the observed response-rate variations. This adaptation may enable the traffic generators 206 to achieve target bandwidth specifications despite the non-deterministic response behavior introduced by memory controller scheduling and DRAM timing constraints.

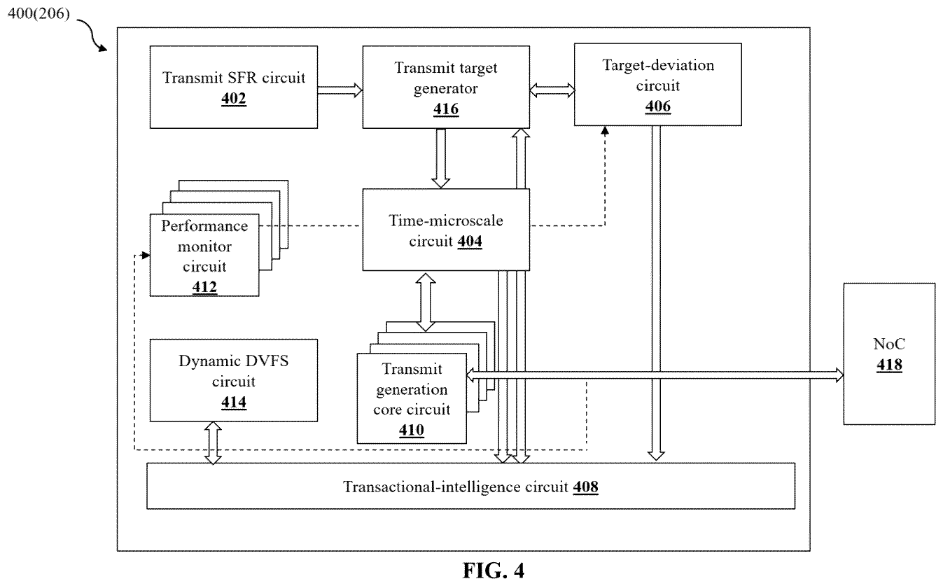

The architecture and working of the traffic generators 206 will be further explained with reference to FIG. 4.

FIG. 4 is a block diagram of a self-configurable traffic generator system 400 in the SoC architecture, in accordance with an embodiment of the disclosure. In an embodiment, the self-configurable traffic generator system 400 may correspond to the traffic generator 206. Accordingly, the terms “self-configurable traffic generator system 400” and “the traffic generator 206” may be interchangeably used throughout the description and the drawings.

For example, the self-configurable traffic generator system 400 may include a transmit special function register (SFR) circuit 402 (herein referred to as the SFR circuit 402) that receives and stores configuration parameters. For example, the SFR circuit 402 may receive one or more initial input parameters. The one or more initial input parameters may include a frequency, an expected bandwidth, a periodicity, and a latency obtained from a silicon-dump or an external target specification. However, embodiments are not limited thereto. The silicon-dump may provide timestamp-level bandwidth, frequency, and latency information extracted from existing silicon measurements, thereby enabling the traffic generators 206 to operate in a silicon-dump replay mode, in which the traffic generators 206 replicates traffic patterns observed in actual silicon operation. The external target specification may provide bandwidth and frequency targets defined by a user or validation environment for scenarios, in which silicon-dump data is unavailable or, in which specific target conditions are to be validated.

A transmit (TX) target generator 416 may be coupled to the SFR circuit 402 and may receive the initial input parameters stored in the SFR circuit 402. The TX target generator 416 may generate bandwidth targets for traffic generation based on the received initial input parameters. The TX target generator 416 may establish macro-level bandwidth objectives that define the overall traffic generation goals for the traffic generators 206.

A time-microscale circuit 404 may be coupled to the TX target generator 416 and may generate micro-level bandwidth targets for traffic generation based on the one or more initial input parameters. For example, the time-microscale circuit 404 may divide the macro-level bandwidth targets received from the TX target generator 416 into granular time periods, thereby generating micro-level bandwidth targets for each granular time period. For example, when the TX target generator 416 may indicate a target bandwidth of 10 gigabytes per second over a time scale of 100 microseconds, the time-microscale circuit 404 may divide this target into micro-level bandwidth targets for each 1 microsecond interval, thereby producing 100 individual bandwidth targets that collectively achieve the macro-level objective. The time-microscale circuit 404 may be positioned centrally in the traffic generator 206 and may interface with multiple components to distribute the micro-level bandwidth targets.

The self-configurable traffic generator system 400 may further include a target-deviation circuit 406 coupled to the time-microscale circuit 404. The target-deviation circuit 406 may estimate, for each logical client, a deviation between an achieved bandwidth and a corresponding micro-level bandwidth target. The target-deviation circuit 406 may monitor real-time system behavior including transaction acceptance patterns and response-rate patterns received from the system backbone. The target-deviation circuit 406 may compute, for each logical client, adaptive weights using an adaptive learning technique. The adaptive learning technique may use data-driven parameter calculation responsive to configuration conditions and may generate adaptive weights for traffic generation based on the calculated parameters. The target-deviation circuit 406 may compute the adaptive weights per logical client based on a transaction acceptance rate, a transaction response rate, and a target-deviation rate indicative of a difference between a target bandwidth and an achieved bandwidth. These parameters may collectively characterize real-time system behavior and may indicate how closely each logical client's performance aligns with its bandwidth objectives. The target-deviation circuit 406 may continuously monitor acceptance and response signals from the system backbone to compute these rates, thereby capturing the effects of contention, interconnect buffering, memory-controller scheduling, and latency variations. By comparing the achieved bandwidth against the micro-level bandwidth target provided by the time-microscale circuit 404, the target-deviation circuit 406 may quantify how far each logical client's performance deviates from its intended bandwidth target.

Using these inputs, the target-deviation circuit 406 may compute adaptive weights tailored to each logical client through a weighted combination that reflects the relative influence of acceptance behavior, response characteristics, and bandwidth deviation. The target-deviation circuit 406 may detect changes in transaction acceptance patterns, particularly in multi-master environments, in which bandwidth availability, buffering behavior, and arbitration decisions may fluctuate and may adjust adaptive weights to compensate for increased or decreased contention. Logical clients having lower transaction acceptance rates may receive higher adaptive weights to support more aggressive transaction issuance, while the logical clients having higher transaction acceptance rates receive reduced adaptive weights to prevent disproportionate consumption of shared resources. Because each logical client may encounter different traffic conditions and contention levels, the target-deviation circuit 406 may perform the computation individually for each logical client to ensure consistent achievement of bandwidth targets across varying system scenarios.

For example, the self-configurable traffic generator system 400 may support up to a configurable number of logical clients per component, thereby allowing for multiple logical clients to be handled by a single traffic generator instance. For example, when the self-configurable traffic generator system 400 is configured to support eight logical clients, the target-deviation circuit 406 may compute eight separate sets of adaptive weights, with each set corresponding to one logical client. Each logical client may receive individually computed adaptive weights based on respective bandwidth requirements and observed system behavior for that logical client. When logical client 0 experiences a transaction acceptance rate of 80 percent while logical client 1 experiences a transaction acceptance rate of 60 percent, the target-deviation circuit 406 may compute different adaptive weights for each logical client to compensate for the differing transaction acceptance rates and to achieve the respective bandwidth targets.

In a further embodiment, the target-deviation circuit 406 may generate a maximum effort estimate for the closest possible achievable bandwidth when target bandwidth specifications may not be achieved due to system constraints. The maximum effort estimate may indicate the bandwidth that the traffic generator may achieve when operating at maximum capacity in the configured degrees of freedom. The maximum effort estimate may provide feedback to validation engineers regarding the gap between target specifications and achievable performance under current system conditions.

The maximum effort estimation process may begin when the target-deviation circuit 406 may detect persistent deviation between the target bandwidth and the achieved bandwidth despite adjustment of transaction parameters by a transactional-intelligence circuit 408. The target-deviation circuit 406 may monitor the achieved bandwidth for each logical client over successive measurement intervals and may compare the achieved bandwidth against the corresponding micro-level bandwidth target. When the achieved bandwidth remains below the target bandwidth for a specified number of consecutive measurement intervals, the target-deviation circuit 406 may initiate the maximum effort estimation process.

The target-deviation circuit 406 may compute the maximum effort estimate based on the current system behavior and the limits of the adjustable parameters. The maximum effort estimate may incorporate the observed transaction acceptance rate, the observed response rate, and the maximum values of the adjustable transaction parameters in the configured degrees of freedom range. The target-deviation circuit 406 may calculate the bandwidth that the traffic generator 206 may achieve when operating with a maximum transaction size, a maximum burst length, a maximum outstanding transaction count, and a maximum operating frequency in the configured limits. The resulting maximum effort estimate may represent the closest achievable bandwidth given the system constraints observed during operation.

The maximum effort estimate may account for non-deterministic system behavior that limits achievable bandwidth. When multi-master contention reduces the transaction acceptance rate below the level required to achieve target bandwidth, the maximum effort estimate may reflect the bandwidth achievable at the observed transaction acceptance rate with maximum transaction parameters. When memory controller scheduling and DRAM timing constraints impose response latencies that limit achievable bandwidth, the maximum effort estimate may incorporate the observed response latency characteristics. The maximum effort estimate may provide a realistic assessment of achievable performance that accounts for the actual system conditions experienced by the traffic generators 206.

The self-configurable traffic generator system 400 may further include the transactional-intelligence circuit 408. The transactional-intelligence circuit 408 may be coupled to the target-deviation circuit 406 and may control one or more transaction parameters based on the adaptive weights received from the target-deviation circuit 406. The one or more transaction parameters may include a transaction size, burst specifications, length parameters, transaction-issue rate with frequency scaling, a number of outstanding transactions, and issue-traffic patterns. However, embodiments are not limited thereto. The transactional-intelligence circuit 408 may span across a lower portion of the traffic generators 206 architecture and may interface with multiple components to coordinate transaction parameter control.

The transactional-intelligence circuit 408 may receive inputs including a transaction acceptance rate, a transaction response rate, a target-deviation value, a current transaction frequency, an average transaction length, an average transaction size, and a stream-and-blank rate. Based on these inputs, the transactional-intelligence circuit 408 may output, for each logical client, an updated average transaction length, an updated average transaction size, a modified transaction frequency, a modified stream-and-blank rate, and a client weight for a slot-machine adaptor. For example, when the target-deviation circuit 406 indicates that logical client 2 achieves 8 gigabytes per second against a target of 10 gigabytes per second, the transactional-intelligence circuit 408 may increase the average transaction length from 64 bytes to 128 bytes and may increase the number of outstanding transactions from 4 to 8 to increase the achieved bandwidth toward the target bandwidth.

In an embodiment, the transactional-intelligence circuit 408 may control three degrees of freedom to enable adaptive traffic generation in response to real-time system behavior. The three degrees of freedom may include intra-transaction parameters, inter-transaction parameters, and frequency scaling. Each degree of freedom may provide a distinct mechanism for adjusting traffic generation characteristics to achieve target bandwidth specifications in non-deterministic system environments.

The first degree of freedom may include intra-transaction parameters including size, burst, and length. The size parameter may indicate the data payload size for each transaction, determining the amount of data transferred per transaction. The burst parameter may indicate the burst characteristics of transactions, including whether transactions may be issued as single transfers or as burst sequences having multiple data beats. The length parameter may indicate the transaction length, thereby defining the number of data beats in a burst transaction. The transactional-intelligence circuit 408 may adjust the intra-transaction parameters to modify the data transfer efficiency of individual transactions. When the transactional-intelligence circuit 408 increases the transaction size from 32 bytes to 64 bytes, each transaction transfers twice the data payload, thereby enabling higher bandwidth achievement with the same transaction-issue rate. When the transactional-intelligence circuit 408 increases the burst length from 4 beats to 8 beats, each burst transaction may transfer additional data beats, thereby improving bandwidth utilization of the system interconnect.

The second degree of freedom may include inter-transaction parameters including a maximum outstanding capability and an issue-traffic pattern. The maximum outstanding capability may indicate the maximum number of transactions that the traffic generator 206 may permit to remain outstanding at a certain time, in which an outstanding transaction is a transaction that is issued but for which a response has not yet been received. The issue-traffic pattern may indicate the temporal pattern for issuing transactions, including stream and blank intervals that define periods of active transaction issuance and periods of idle operation. The transactional-intelligence circuit 408 may adjust the inter-transaction parameters to modify the relationship between consecutive transactions and the overall traffic flow pattern. When the transactional-intelligence circuit 408 increases the maximum outstanding capability from 8 transactions to 16 transactions, the traffic generator 206 may issue additional transactions before waiting for responses, thereby enabling higher bandwidth achievement in systems with longer response latencies. When the transactional-intelligence circuit 408 modifies the issue-traffic pattern to reduce blank intervals between transaction streams, the self-configurable traffic generator system 400 may maintain higher sustained transaction rates.

The third degree of freedom may include frequency scaling. Frequency scaling may adjust the operating frequency at which the traffic generator 206 issues transactions, thereby affecting the transaction-issue rate. The transactional-intelligence circuit 408 may request frequency scaling adjustments through a transmit dynamic voltage and frequency scaling (DVFS) circuit 414 when adjustment of the intra-transaction parameters and the inter-transaction parameters may be insufficient to satisfy bandwidth targets. When the transactional-intelligence circuit 408 may request an increase in operating frequency from 400 megahertz to 500 megahertz, the transaction-issue rate may increase proportionally, thereby enabling higher bandwidth achievement without modifying transaction size or outstanding capability.

Accordingly, the self-configurable traffic generator system 400 may be configured with configurable degrees of freedom range that provides a range of options with respect to controlling the transactional-intelligence circuit 408. The configurable degrees of freedom range may indicate minimum and maximum values for each adjustable parameter, thereby establishing boundaries in which the transactional-intelligence circuit 408 operates during adaptive traffic generation. For the intra-transaction parameters, the configurable degrees of freedom range may indicate minimum and maximum transaction sizes, minimum and maximum burst lengths, and supported burst types. For the inter-transaction parameters, the configurable degrees of freedom range may indicate minimum and maximum outstanding transaction counts and supported issue-traffic patterns. For frequency scaling, the configurable degrees of freedom range may indicate minimum and maximum operating frequencies and frequency step sizes for scaling operations.

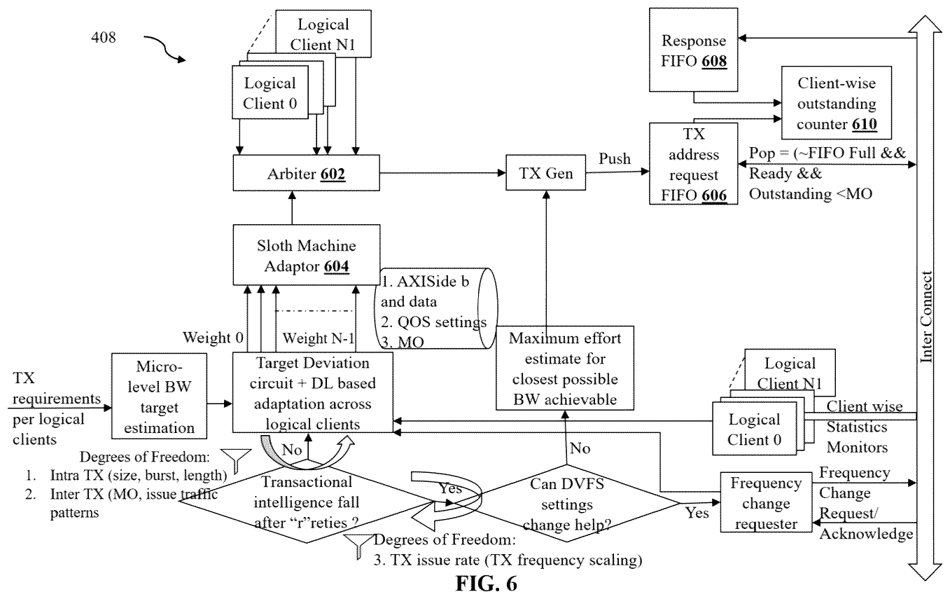

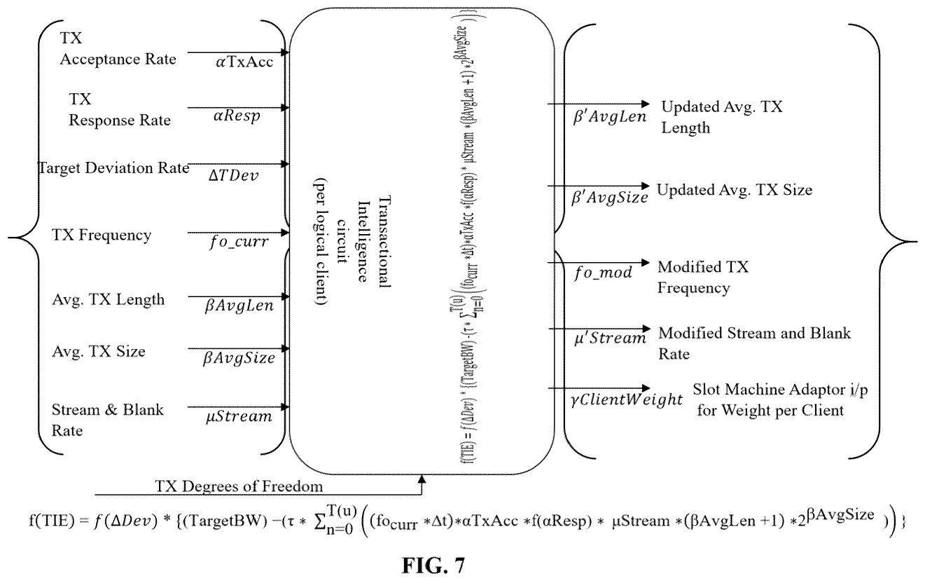

Accordingly, the transactional-intelligence circuit 408 may operate in the configurable degrees of freedom range to adapt traffic generation while respecting system constraints and validation requirements. When a validation scenario requires transactions having sizes between 64 bytes and 256 bytes, the configurable degrees of freedom range may constrain the transactional-intelligence circuit 408 to adjust transaction sizes in this range, thereby preventing the transactional-intelligence circuit 408 from generating transactions having sizes outside the specified bounds. The configurable degrees of freedom range may enable validation engineers to constrain the adaptive behavior of the traffic generator 206 to match specific validation objectives while permitting the transactional-intelligence circuit 408 to adapt in the specified constraints. The structure and operation of the transactional-intelligence circuit 408 will be further explained with reference to FIGS. 6 and 7.

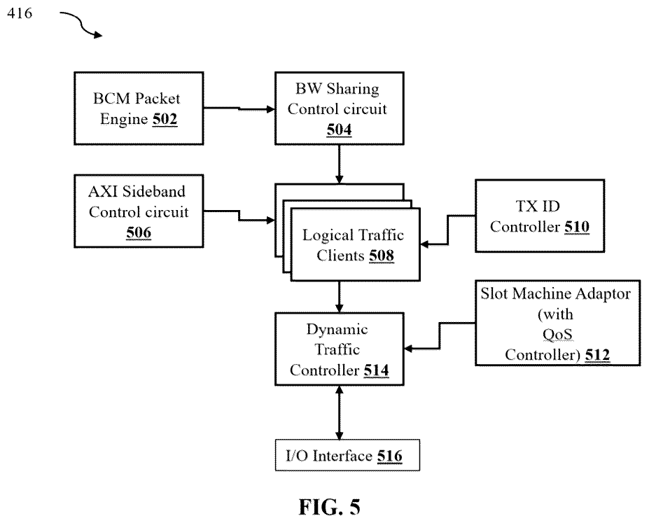

The self-configurable traffic generator system 400 may further include a transmit generation core circuit 410. The transmit generation core circuit 410 may be coupled to the transactional-intelligence circuit 408 and may generate traffic for a plurality of clients based on the controlled one or more transaction parameters. The transmit generation core circuit 410 may receive the modified transaction parameters from the transactional-intelligence circuit 408 and may generate actual traffic transactions according to the specified transaction size, burst specifications, length parameters, and issue-traffic patterns. The transmit generation core circuit 410 may receive micro-level bandwidth targets from the time-microscale circuit 404 to coordinate traffic generation timing with the target bandwidth objectives. The structure and working of the transmit generation core circuit 410 will be further explained in detail with reference to FIG. 5.

The self-configurable traffic generator system 400 may further include a performance monitor circuit 412 coupled to the SFR circuit 402. The performance monitor circuit 412 may capture traffic information generated by the traffic generator 206. For example, the performance monitor circuit 412 may capture traffic information in a silicon-compatible format, thereby enabling the captured data to be compared with silicon measurements and to be used for post-silicon debug scenarios. The performance monitor circuit 412 may interface with the transmit DVFS circuit 414 to capture frequency scaling events and correlate the frequency scaling events with captured traffic statistics.

In a further embodiment, the performance monitor circuit 412 may include client-wise statistics monitors that capture per-client traffic statistics to be used by the target-deviation circuit 406. The client-wise statistics monitors may track performance metrics for Logical Client 0 through Logical Client N-1, including achieved bandwidth, transaction acceptance rates, response latencies, and outstanding transaction counts for each logical client. The client-wise statistics monitors may provide the captured per-client traffic statistics to the target-deviation circuit 406, thereby enabling the target-deviation circuit 406 to compute adaptive weights based on the observed performance characteristics of each logical client.

The traffic generator system 206 may further include the transmit dynamic voltage and frequency scaling (DVFS) circuit 414 coupled to the transactional-intelligence circuit 408. The transmit DVFS circuit 414 may adjust an operating frequency in response to a frequency-change request when adjustment of the transaction parameters is insufficient to satisfy bandwidth targets. The transmit DVFS circuit 414 may receive frequency-change requests from the transactional-intelligence circuit 408 and may modify the transaction-issue rate based on the adjusted operating frequency. For example, when the transactional-intelligence circuit 408 may determine that increasing transaction size and outstanding transaction count to maximum values still results in achieved bandwidth below the target bandwidth, the transactional-intelligence circuit 408 may transmit a frequency-change request to the transmit DVFS circuit 414, which increases the operating frequency from 500 megahertz to 600 megahertz to increase the transaction-issue rate. Accordingly, the transmit DVFS circuit 414 may receive frequency-change requests from the transactional-intelligence circuit 408 and may implement frequency adjustments to modify the transaction-issue rate of the traffic generators 206.

In an embodiment, the transmit DVFS circuit 414 may operate as part of a hierarchical adaptation mechanism in the traffic generators 206. When the transactional-intelligence circuit 408 determines that adjustment of intra-transaction parameters and inter-transaction parameters fails to achieve target bandwidth specifications, the transactional-intelligence circuit 408 may generate a frequency-change request directed to the transmit DVFS circuit 414. The transmit DVFS circuit 414 may process the frequency-change request and may adjust the operating frequency of the traffic generators 206 to increase or decrease the transaction-issue rate. The transmit DVFS circuit 414 may provide a frequency-change acknowledgment to the transactional-intelligence circuit 408 upon completion of the frequency adjustment, thereby enabling the transactional-intelligence circuit 408 to incorporate the modified operating frequency into subsequent transaction parameter calculations.

The traffic generators 206 may connect to a Network on Chip (NoC) 418, which function as the communication backbone for transmitting generated traffic to other system components. The NoC 418 may receive traffic from the transmit generation core circuit 410 and may provide communication with external system elements including the system interconnect 302 and the configurable memory controller 208. Bidirectional communication paths may exist between the traffic generators 206 and the NoC 418, thereby enabling the traffic generators 206 to receive transaction acceptance signals and transaction response signals from the system backbone through the NoC 418. The transactional-intelligence circuit 408 may adapt the traffic generation based on the received transaction acceptance signals and transaction response signals.

The interconnection among the components in the traffic generators 206 may enable closed-loop adaptation of transaction parameters. The SFR circuit 402 may provide initial configuration to the TX target generator 416, which generates macro-level bandwidth targets for the time-microscale circuit 404. The time-microscale circuit 404 may generate micro-level bandwidth targets that the target-deviation circuit 406 may compare against achieved bandwidth to compute adaptive weights. The transactional-intelligence circuit 408 may receive the adaptive weights and may control transaction parameters provided to the transmit generation core circuit 410. The transmit generation core circuit 410 may generate traffic that flows through the NoC 418 to the system backbone, and the performance monitor circuit 412 may capture traffic statistics that feed back to the target-deviation circuit 406 for continuous adaptation.

FIG. 5 is a block diagram of the transmit generation core circuit 410, in accordance with an embodiment of the disclosure. For example, the transmit generation core circuit 410 may include a Bus Control Monitor (BCM) packet engine 502 that generates packets for transmission to the system backbone. The BCM packet engine 502 may receive transaction parameters from the transactional-intelligence circuit 408 and may construct packets conforming to the bus protocol requirements of the system interconnect. The BCM packet engine 502 may format transaction addresses, data payloads, and control information into packet structures suitable for transmission through the NoC backbone.

The transmit generation core circuit 410 may include a bandwidth (BW) sharing control circuit 504 that is coupled to the BCM packet engine 502 and may manage bandwidth allocation among the logical clients. The BW sharing control circuit 504 may receive per-client weights from the transactional-intelligence circuit 408 and may distribute available bandwidth among the logical clients according to the received weights. For example, when logical client 0 receives a weight of 0.6 and logical client 1 receives a weight of 0.4, the BW sharing control circuit 504 may allocate 60 percent of the available bandwidth to logical client 0 and 40 percent of the available bandwidth to logical client 1.

The transmit generation core circuit 410 may include an Advanced eXtensible Interface (AXI) sideband control circuit 506 coupled to logical traffic clients 508 to provide sideband signaling capabilities. The AXI sideband control circuit 506 may handle sideband information including quality of service indicators, transaction identifiers, and control signals that accompany transactions issued by the logical traffic clients 508. The AXI sideband control circuit 506 may format sideband data according to the AXI protocol requirements and may coordinate sideband signaling with the packet generation performed by the BCM packet engine 502.

The logical traffic clients 508 may represent multiple client instances that generate traffic in the transmit generation core circuit 410. Each of the logical traffic clients 508 may operate with distinct traffic characteristics including traffic type, quality of service settings, traffic rate, and traffic pattern parameters. The traffic type parameter may indicate whether the logical traffic client generates read transactions, write transactions, or a combination thereof. The quality of service parameter may indicate the priority level and service requirements for transactions generated by the logical traffic client. The traffic rate parameter may indicate the target transaction rate for the logical traffic client. The traffic pattern parameter may indicate the temporal distribution of transactions including burst patterns, stream intervals, blank intervals, and inter-transaction timing.

The transmit generation core circuit 410 may include a Transaction Identifier (TX ID) control circuit 510 coupled to the logical traffic clients 508. The TX ID control circuit 510 may manage transaction identifiers for transactions issued by the logical traffic clients 508. The TX ID control circuit 510 may assign transaction identifiers to outgoing transactions and may track outstanding transactions based on the assigned transaction identifiers. The TX ID control circuit 510 may coordinate with the BW sharing control circuit 504 to ensure that transaction identifier assignment aligns with bandwidth allocation decisions.

The transmit generation core circuit 410 may further include a slot-machine adaptor with Quality of Service controller 512 coupled to both the TX ID control circuit 510 and a dynamic traffic controller 514. The slot-machine adaptor with Quality of Service controller 512 may receive per-client weights from the transactional-intelligence circuit 408 and may implement a slot-based arbitration mechanism that allocates transaction slots to the logical traffic clients 508 based on the received weights. The slot-machine adaptor with Quality of Service controller 512 may incorporate quality of service differentiation, thereby enabling higher-priority logical traffic clients to receive preferential access to transaction slots when contention occurs among multiple logical traffic clients.

The dynamic traffic controller 514 may receive inputs from the logical traffic clients 508 and the slot-machine adaptor with Quality of Service controller 512 to dynamically manage traffic flow in the transmit generation core circuit 410. The dynamic traffic controller 514 may adjust traffic generation parameters in response to feedback from the system backbone, including transaction acceptance signals and transaction response signals. The dynamic traffic controller 514 may coordinate with the BW sharing control circuit 504 to implement bandwidth allocation decisions and with the slot-machine adaptor with Quality of Service controller 512 to implement arbitration decisions.

The transmit generation core circuit 410 may include an Input/Output (I/O) Interface 516. The I/O Interface 516 may provide external connectivity for the transmit generation core circuit 410. The I/O Interface 516 may connect the transmit generation core circuit 410 to the NoC backbone and may handle the transmission of generated packets to the system interconnect. The I/O Interface 516 may receive transaction acceptance signals and transaction response signals from the system backbone and may provide these signals to the dynamic traffic controller 514 for use in adaptive traffic generation.

The transactional-intelligence circuit 408 may include an arbiter that allocates bandwidth among a configurable number of logical clients based on the adaptive weights. The arbiter may receive the adaptive weights computed by the target-deviation circuit 406 and may determine how bandwidth is distributed among the logical traffic clients 508 in the transmit generation core circuit 410. The arbiter may implement a weighted arbitration scheme, in which logical traffic clients 508 with higher adaptive weights receive proportionally greater bandwidth allocation. When the target-deviation circuit computes adaptive weights of 0.5, 0.3, and 0.2 for three logical traffic clients 508, the arbiter may allocate bandwidth in the ratio of 5:3:2 among the three Logical traffic clients 508.

The configurable number of logical clients may enable the transmit generation core circuit 410 to support varying numbers of traffic sources in a single traffic generator instance. The arbiter may adapt the bandwidth allocation to accommodate the configured number of logical clients, distributing the adaptive weights across the active logical traffic clients 508. When the transmit generation core circuit 410 is configured to support four logical clients, the arbiter may allocate bandwidth among the four logical clients based on the four corresponding adaptive weights received from the target-deviation circuit 408.

FIG. 6 is a block diagram of the transactional-intelligence circuit 408, in accordance with an embodiment of the disclosure. For example, the transactional-intelligence circuit 408 may include multiple logical clients, an arbiter 602, a slot-machine adaptor 604, a transaction-address request First-In-First-Out (FIFO) buffer 606, a response FIFO buffer 608, a client-wise outstanding counter 610, and a target-deviation circuit with deep learning based adaptation capabilities.

The transactional-intelligence circuit 408 may include multiple logical clients designated as Logical Client 0 through Logical Client N−1, in which N represents the configurable number of logical clients supported by the traffic generators 206. Each logical client may generate transaction requests according to the respective traffic parameters and bandwidth requirements. The logical clients may provide transaction requests to an arbiter that manages access among the logical clients.

In an embodiment, the arbiter 602 may allocate bandwidth among a configurable number of logical clients based on the adaptive weights. For example, the arbiter 602 may receive transaction requests from Logical Client 0 through Logical Client N−1 and may determine which logical client receives access to issue transactions to the system backbone during each arbitration cycle. The arbiter 602 may implement weighted arbitration based on adaptive weights received from the target-deviation circuit, thereby allocating transaction opportunities to the logical clients in proportion to the respective weights. When Logical Client 0 receives a weight of 0.4 and Logical Client 1 may receive a weight of 0.6, the arbiter 602 may allocate transaction opportunities such that Logical Client 1 may receive 50 percent more opportunities than Logical Client 0 over a measurement interval.

The transactional-intelligence circuit 408 may further include the transaction-address request FIFO buffer 606 and the response FIFO buffer 608. The transaction-address request FIFO buffer 606 may store transaction requests that are arbitrated and are pending transmission to the system backbone. The response FIFO buffer 608 may store transaction responses received from the system backbone that are pending delivery to the corresponding logical clients.

The arbiter 602 may control push operations for the transaction-address request FIFO buffer 606 and pop operations for the response FIFO buffer 608. When the arbiter 602 grants access to a logical client, the arbiter 602 may push the transaction request from that logical client into the transaction-address request FIFO buffer 606. The transaction request may remain in the transaction-address request FIFO buffer 606 until the system backbone is ready to accept the transaction. When a transaction response arrives from the system backbone, the response may be stored in the response FIFO buffer 608, and the arbiter 602 may control the pop operation to deliver the response to the corresponding logical client based on transaction identifier matching.

A TX Gen circuit may receive arbitrated transaction requests from the arbiter 602 and may push the arbitrated transaction requests to the transaction-address request FIFO buffer 606. The transaction-address request FIFO buffer 606 may operate based on a pop condition that evaluates whether the FIFO is not full, whether the system is ready, and whether outstanding transactions are less than a maximum outstanding limit.

The traffic generators 206 (e.g., the transactional-intelligence circuit 408) may further include a client-wise outstanding counter 610 that tracks outstanding transactions per logical client. The client-wise outstanding counter 610 may determine whether a number of outstanding transactions is less than a maximum outstanding capability before issuing new transactions. The client-wise outstanding counter 610 may maintain a separate count for each logical client, incrementing the count when a transaction is issued for that logical client and decrementing the count when a response is received for that logical client. The client-wise outstanding counter 610 may provide the outstanding transaction count for each logical client to the pop condition evaluation logic, thereby enabling the traffic generators 206 to enforce the maximum outstanding capability on a per-logical-client basis.

For example, when Logical Client 0 has a maximum outstanding capability of 8 transactions and the client-wise outstanding counter 610 indicates that Logical Client 0 currently has 8 outstanding transactions, the pop condition may evaluate to false for transaction requests from Logical Client 0. Thus, additional transaction transactions may be prevented from being issued until a response is received and the outstanding count decreases below the maximum. This per-client tracking operation may enable the traffic generators 206 to manage outstanding transactions independently for each logical client, thereby preventing any single logical client from consuming excessive outstanding transaction capacity at the expense of other logical clients.

Further, the transactional-intelligence circuit 408 may include a target-deviation circuit integrated with a deep learning based adaptation mechanism operating across the logical clients. The target-deviation circuit may receive transaction requirements for each logical client and may perform micro-level bandwidth target estimation based on the received requirements and observed system behavior. The deep learning based adaptation mechanism may use data-driven parameter calculation to generate adaptive weights that reflect the relationship between target bandwidth specifications and achieved bandwidth for each logical client.

For example, the target-deviation circuit may output adaptive weights ranging from weight_0 to weight_N−1, with each adaptive weight corresponding to one of the logical clients from Logical Client 0 through Logical Client N−1. The adaptive weights feed into a slot-machine adaptor 604 that implements weighted arbitration among the logical clients. The adaptive weights may reflect the adaptive adjustments computed by the target-deviation circuit based on transaction acceptance rates, transaction response rates, and target deviation rates observed for each logical client. When Logical Client 2 experiences a lower transaction acceptance rate than Logical Client 3, the target-deviation circuit may increase weight_2 relative to weight_3 to compensate for the reduced acceptance probability experienced by Logical Client 2.

The traffic generator system may support dynamic weight-based adaptation across logical clients using deep learning based techniques. The deep learning based techniques enable the target-deviation circuit to learn the relationship between input parameters and achieved bandwidth through observation of system behavior over time. The target-deviation circuit may adjust the weights for each logical client based on detected patterns in transaction acceptance rates, response latencies, and bandwidth deviations. The dynamic weight-based adaptation may enable the traffic generators 206 to respond to changing system conditions without external intervention, adjusting the bandwidth allocation among logical clients to achieve target specifications despite non-deterministic system behavior.

A feedback loop in the transactional-intelligence circuit 408 may include the client-wise statistics monitors that track performance for each logical client and provide feedback to the target-deviation circuit 408. The target-deviation circuit 408 may process the feedback from the client-wise statistics monitors and may update the adaptive weights for each logical client based on the observed performance metrics. The updated adaptive weights may flow to the slot-machine adaptor 604 and the arbiter 602, thereby influencing subsequent arbitration decisions and bandwidth allocation among the logical clients.

The transactional-intelligence circuit 408 may include decision logic that evaluates whether transactional intelligence fails after a specified number of retries. When the transactional-intelligence circuit 408 may adjust transaction parameters through multiple iterations without achieving target bandwidth specifications, the decision logic may determine that transactional intelligence is failed to achieve the targets through parameter adjustment alone. The decision logic may evaluate whether dynamic voltage and frequency scaling (DVFS) adjustments are beneficial in achieving the target bandwidth. When DVFS adjustment is beneficial, a frequency change requester may communicate with a frequency change request/acknowledge circuit to adjust the operating frequency of the traffic generators 206.

In an embodiment, the transactional-intelligence circuit 408 may adjust the transaction parameters in response to non-deterministic system behavior caused by at least one of multi-master contention on a system interconnect, priority among masters, buffer depths in a network-on-chip backbone, and transient traffic conditions. The non-deterministic system behavior may arise from dynamic interactions among multiple components in the SoC architecture that collectively influence transaction acceptance patterns and transaction response latencies experienced by the traffic generators 206.

Multi-master contention on a system interconnect may occur when multiple masters simultaneously attempt to access shared interconnect resources. In a typical SoC architecture, numerous processing engines, direct memory access controllers, and other traffic-generating components may be connected to a common system interconnect that routes transactions to memory controllers and peripheral devices. When multiple masters issue transactions concurrently, the system interconnect may arbitrate among the competing requests, thereby granting access to one master while other masters wait for subsequent arbitration cycles. The transaction acceptance rate experienced by each master may depend on the aggregate traffic load from all masters connected to the system interconnect, and on the arbitration outcomes that determine which master receives access during each cycle.

The transactional-intelligence circuit 408 may monitor transaction acceptance signals received from the system backbone and may detect variations in acceptance rates caused by multi-master contention. When the transaction acceptance rate decreases due to increased contention from other masters, the transactional-intelligence circuit 408 may adjust transaction parameters to compensate for the reduced acceptance probability. The transactional-intelligence circuit 408 may increase the number of outstanding transactions to maintain higher transaction throughput despite lower acceptance rates, and may adjust issue-traffic patterns to concentrate transaction issuance during periods of lower contention when acceptance rates are higher.

Priority among masters may influence transaction acceptance patterns by determining the order in which competing transaction requests are serviced by the system interconnect and NoC backbone. Masters with higher priority levels may receive preferential access during arbitration, resulting in higher transaction acceptance rates and lower response latencies compared to masters with lower priority levels. The priority assignments may reflect the relative urgency and service requirements of different traffic sources in the SoC architecture. Real-time processing engines that require guaranteed response latency bounds receive higher priority than background processing engines that tolerate variable response latency.

The transactional-intelligence circuit 408 may account for priority among masters when adjusting transaction parameters. When the traffic generators 206 operates at a lower priority level relative to other masters in the system, the transactional-intelligence circuit 408 may anticipate reduced transaction acceptance rates and may adjust parameters accordingly. The transactional-intelligence circuit 408 may increase transaction sizes to transfer more data per accepted transaction, compensating for the reduced number of transaction opportunities available to lower-priority masters. The transactional-intelligence circuit 408 may adjust the maximum outstanding transaction count to maintain sufficient pending transactions to utilize available bandwidth when arbitration grants access to the traffic generators 206.

Buffer depths in a network-on-chip backbone may affect transaction acceptance patterns by determining the capacity of the NoC backbone to absorb transaction bursts from multiple masters. The NoC backbone may include buffers at various stages of the interconnect hierarchy that temporarily store transactions in transit between masters and destination components. When buffer occupancy approaches capacity, the NoC backbone may apply backpressure to upstream components, thereby reducing transaction acceptance rates until buffer space becomes available. The buffer depths at each stage of the NoC hierarchy may collectively determine the burst absorption capacity of the interconnect and the sensitivity of transaction acceptance rates to traffic variations.

The transactional-intelligence circuit 408 may adapt to buffer depth constraints in the NoC backbone by monitoring transaction acceptance patterns and detecting backpressure conditions. When transaction acceptance rates decrease due to buffer congestion in the NoC backbone, the transactional-intelligence circuit 408 may reduce the transaction-issue rate to avoid exacerbating the congestion. The transactional-intelligence circuit 408 may adjust issue-traffic patterns to introduce spacing between transaction bursts, allowing buffers in the NoC backbone to drain before subsequent bursts are issued. This adaptive behavior may enable the traffic generators 206 to achieve sustained bandwidth without overwhelming the buffer capacity of the NoC backbone.

The transient traffic conditions may arise from time-varying traffic patterns generated by other masters in the SoC architecture. Processing engines may execute workloads with varying computational and memory access requirements over time, resulting in fluctuating traffic loads on the system interconnect and NoC backbone. During periods of high activity from other masters, the traffic generators 206 may experience reduced transaction acceptance rates and increased response latencies. During periods of low activity from other masters, the traffic generators 206 may experience improved acceptance rates and reduced response latencies. The transient nature of these traffic conditions may prevent static traffic generation approaches from achieving consistent bandwidth performance.

Accordingly, the transactional-intelligence circuit 408 may respond to the transient traffic conditions by continuously monitoring system behavior and may adjust transaction parameters in response to observed variations. The transactional-intelligence circuit 408 may detect changes in transaction acceptance rates and transaction response latencies that indicate shifts in traffic conditions in the system. When acceptance rates improve due to reduced traffic from other masters, the transactional-intelligence circuit 408 may increase the transaction-issue rate and outstanding transaction count to capitalize on the improved conditions. When acceptance rates deteriorate due to increased traffic from other masters, the transactional-intelligence circuit 408 may reduce the transaction-issue rate and may adjust transaction parameters to maintain stable operation without excessive transaction rejection.

In an embodiment, the traffic generators 206 may achieve target bandwidths specified as a read bandwidth ‘x’ bits per second and a write bandwidth ‘xw’ bits per second over a time scale ‘to’ with a maximum outstanding capability ‘m’ at an operating frequency ‘fo’ and an average burst length ‘AL’. The read bandwidth target ‘x’ may indicate the data transfer rate for read transactions that the traffic generators 206 attempts to achieve during the time scale ‘to’. The write bandwidth target ‘xw’ may indicate the data transfer rate for write transactions that the traffic generators 206 attempts to achieve during the same time scale. The time scale ‘to’ may define the measurement interval over which the bandwidth targets are evaluated, thereby establishing the temporal granularity for bandwidth achievement assessment.

The maximum outstanding capability ‘m’ may indicate the maximum number of transactions that the traffic generators 206 permits to remain outstanding at a certain time. The maximum outstanding capability may constrain the number of pending transactions for which responses have not yet been received, thereby limiting the depth of the transaction pipeline between the traffic generators 206 and the memory subsystem. The operating frequency ‘fo’ may indicate the clock frequency at which the traffic generators 206 operates, thereby determining the rate at which the traffic generators 206 issues transactions to the system backbone. The average burst length ‘AL’ may indicate the average number of data beats per burst transaction, influencing the data transfer efficiency of individual transactions.

The transactional-intelligence circuit 408 may compute adjustments to transaction parameters based on the relationship between the target bandwidth specifications and the achieved bandwidth observed during operation. When the achieved read bandwidth falls below the target bandwidth of ‘x’ bits per second, the transactional-intelligence circuit 408 may increase transaction parameters such as the average burst length, the number of outstanding transactions, or the transaction-issue rate to increase the achieved bandwidth toward the target bandwidth. When the achieved write bandwidth falls below the target bandwidth of ‘xw’ bits per second, the transactional-intelligence circuit 408 may apply corresponding adjustments to write transaction parameters toward the target bandwidth.

The transactional-intelligence circuit 408 may operate in the constraints imposed by the maximum outstanding capability ‘m’ and the operating frequency ‘fo’ when adjusting transaction parameters. The transactional-intelligence circuit 408 may not increase the number of outstanding transactions beyond the maximum outstanding capability ‘m’, as exceeding this limit violates system constraints and results in transaction rejection. The transactional-intelligence circuit 408 may request frequency scaling adjustments through the transmit DVFS circuit 414 when the operating frequency ‘fo’ proves insufficient to achieve target bandwidth specifications through transaction parameter adjustment alone.

The average burst length ‘AL’ may function as both an input parameter and an adjustable parameter in the transactional-intelligence circuit 408. The initial average burst length ‘AL’ establishes a baseline for burst transaction characteristics, and the transactional-intelligence circuit 408 may adjust the average burst length upward or downward based on observed system behavior and bandwidth deviation. Increasing the average burst length transfers more data per transaction, improving bandwidth efficiency when transaction acceptance rates are limited. Decreasing the average burst length may reduce per-transaction data transfer but may enable more frequent transaction issuance, which proves beneficial when response latencies are the limiting factor for bandwidth achievement.

FIG. 7 is a working diagram of the transactional-intelligence circuit 408 operating on a per logical client basis, in accordance with an embodiment of the disclosure. The transactional-intelligence circuit 408 may receive multiple input parameters and may generate corresponding output parameters for controlling traffic generation characteristics on a per-logical-client basis.

The input parameters provided to the transactional-intelligence circuit 408 may include a TX acceptance rate, a TX response rate, a target deviation rate, a TX frequency, an average TX length, an average TX size, and a stream-and-blank rate. The TX acceptance rate may represent the ratio of accepted transactions to issued transactions for the logical client over a measurement interval. The TX response rate may represent the rate at which the system backbone returns responses to outstanding transactions for the logical client. The target deviation rate may represent the difference between a target bandwidth and an achieved bandwidth for the logical client. The TX frequency may represent the current operating frequency at which the traffic generators 206 issues transactions. The average TX length may represent the average number of data beats per transaction for the logical client. The average TX size may represent the average data payload size per transaction for the logical client. The stream-and-blank rate may represent the ratio of active transaction streaming periods to idle periods in the traffic pattern for the logical client.

The transactional-intelligence circuit 408 may process the input parameters and may generate several output parameters for each logical client. The output parameters may include an updated average TX length, an updated average TX size, a modified TX frequency, a modified stream-and-blank rate, and a slot-machine adaptor input for weight per client. The updated average TX length may represent an adjusted transaction length value computed by the transactional-intelligence circuit 408 based on the observed system behavior and bandwidth deviation. The updated average TX size may represent an adjusted transaction size value computed to improve bandwidth achievement. The modified TX frequency may represent an adjusted operating frequency value when frequency scaling is applied. The modified stream-and-blank rate may represent an adjusted ratio of streaming to idle periods in the traffic pattern. The slot-machine adaptor input for weight per client may represent the adaptive weight computed for the logical client that influences arbitration decisions in the slot-machine adaptor 604.

In the self-configurable traffic generator system 400, the transactional-intelligence circuit 408 may compute, for each logical client, an output as a function of a target-deviation value, a target bandwidth value, a current operating frequency, a transaction acceptance-rate value, a response-rate value, a stream-rate value, an average transaction length, and an average transaction size. The transactional-intelligence circuit 408 may output, for each logical client, an updated average transaction length, an updated average transaction size, a modified transaction frequency, a modified stream-and-blank rate, and a client weight for the slot-machine adaptor.

In an embodiment, the transactional-intelligence circuit 408 may compute according to the following formula:

$$f ( TIE ) = f ( Δ Dev ) \times \{ ( TargetBW ) - ( τ \times {\sum }_{n = 0}^{T ( U )} ( {fo}_{c u r r} \times Δ t ) \times α TxAcc \times f ( α Resp ) \times μ Stream \times ( β AvgLen + 1 ) \times {2}^{β AvgSize} ) \} \qquad ( 1 )$$

In equation (1), f(ΔDev) may represent a function of the target deviation value that scales the output based on the magnitude of deviation between target bandwidth and achieved bandwidth. The term TargetBW may represent the target bandwidth value specified for the logical client. The term z may represent a scaling factor applied to the summation. The summation

$${\sum }_{n = 0}^{T ( u )}$$

may accumulate values over the micro-level time intervals from zero to the total number of micro-intervals T(u). The term fo_{curr} may represent the current operating frequency, and Δt may represent the time interval for each micro-level period. The term αTxAcc may represent the transaction acceptance rate value. The term f(αResp) may represent a function of the response rate value. The term μStream may represent the stream rate value. The term βAvgLen may represent the average transaction length, with the addition of one accounting for the base transaction beat. The term 2^{βAvgSize} may represent the transaction size as a power of two, in which βAvgSize may represent the average transaction size exponent.

The transactional-intelligence circuit 408 may compute the difference between the target bandwidth and the estimated achievable bandwidth based on current operating parameters. When the computed difference is positive, the target bandwidth may exceed the estimated achievable bandwidth, indicating that the transactional-intelligence circuit 408 may adjust transaction parameters upward to increase achieved bandwidth. When the computed difference is negative, the estimated achievable bandwidth may exceed the target bandwidth, indicating that the transactional-intelligence circuit 408 may reduce transaction parameters to avoid exceeding the target bandwidth.

The self-configurable traffic generator system 400 may handle non-deterministic factors including a read response latency ‘trL’, a write response latency ‘twL’, and a transaction acceptance probability ‘pacc’. The read response latency ‘trL’ may represent the time interval between issuance of a read request packet and receipt of the corresponding read response from the system backbone. The write response latency ‘twL’ may represent the time interval between issuance of a write request packet and receipt of the corresponding write acknowledgment from the system backbone. The transaction acceptance probability ‘pacc’ may represent the probability that the system backbone accepts a transaction issued by the traffic generators 206 during a certain arbitration cycle.

The read response latency ‘trL’ and the write response latency ‘twL’ may be handled independently for read and write operations in the transactional-intelligence circuit 408. The transactional-intelligence circuit 408 may maintain separate tracking of response latencies for read transactions and write transactions, thereby enabling independent adaptation of read transaction parameters and write transaction parameters based on the respective latency characteristics. When the read response latency ‘trL’ increases due to memory controller scheduling or DRAM timing constraints, the transactional-intelligence circuit 408 may adjust read transaction parameters independently of write transaction parameters. When write response latency ‘twL’ increases, the transactional-intelligence circuit 408 may adjust write transaction parameters without affecting read transaction parameter settings.

The transaction acceptance probability ‘pacc’ may be handled independently for read and write operations. The transactional-intelligence circuit 408 may track separate acceptance probabilities for read transactions and write transactions, as the system backbone applies different arbitration and scheduling decisions to read and write traffic. When the read transaction acceptance probability differs from the write transaction acceptance probability due to priority settings or buffer allocation in the system interconnect, the transactional-intelligence circuit 408 may compute separate adaptive weights for read and write traffic streams. This independent handling of read and write acceptance probabilities may enable the traffic generators 206 to achieve target read bandwidth and target write bandwidth specifications despite differing acceptance conditions for the two traffic types.

The non-deterministic factors ‘trL’, ‘twL’, and ‘pacc’ may collectively influence the achievable bandwidth for each logical client. The transactional-intelligence circuit 408 may incorporate these factors into the computation of adaptive weights and transaction parameter adjustments. When the read response latency ‘trL’ increases, the transactional-intelligence circuit 408 may increase the number of outstanding read transactions to maintain read bandwidth despite the increased latency. When the transaction acceptance probability ‘pacc’ decreases for write transactions, the transactional-intelligence circuit 408 may increase the write transaction issue rate to compensate for the reduced acceptance probability. The independent handling of these non-deterministic factors for read and write operations may enable the traffic generators 206 to achieve balanced bandwidth performance across both traffic types in non-deterministic system environments.

Accordingly, in an embodiment, the transactional-intelligence circuit 408 may adjust the transaction parameters responsive to response-rate variations caused by memory-controller scheduling and intrinsic DRAM timing requirements including self-refresh, read-to-write, read-to-read, and write-to-write timing constraints.

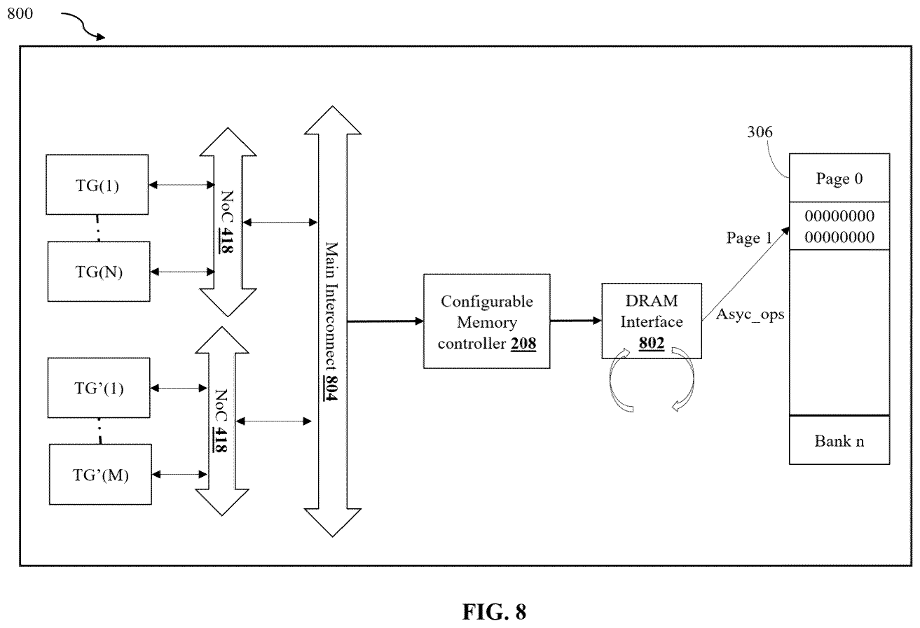

FIG. 8 is a block diagram of a system architecture 800 with multiple traffic generators communicating via a hierarchical backbone, in accordance with an embodiment of the disclosure. The system architecture 800 may include a plurality of traffic generators designated as TG(1) through TG(N) and TG′(1) through TG′(M), each connected to respective NoC interfaces 418. The system architecture 800 may include a main interconnect 804, the configurable memory controller 208, a DRAM interface 802, and the DRAM memory 306.

The traffic generators TG(1) through TG(N) may form a first traffic-generator group connected through one NoC interface 418. Each traffic generator in the first traffic-generator group may generate traffic according to the respective configuration parameters and adaptive weights computed by the corresponding target-deviation circuit 408. The traffic generators TG′(1) through TG′(M) may form a second traffic-generator group connected through a separate NoC interface 418. Each traffic generator in the second traffic-generator group may operate independently with distinct bandwidth targets and traffic characteristics. The grouping of traffic generators into separate NoC interfaces 418 may reflect the hierarchical organization of the SoC architecture, in which traffic generators serving related functional blocks connect through a common NoC interface before reaching the main interconnect 804.

The main interconnect 804 may function as a central communication pathway that connects the NoC interfaces 418 to the configurable memory controller 208. The main interconnect 804 may receive traffic from the first traffic-generator group of traffic generators TG(1) through TG(N) via one NoC interface 418 and may receive traffic from the second traffic-generator group of traffic generators TG′(1) through TG′(M) via the separate NoC interface 418. The main interconnect 804 may aggregate traffic from both NoC interfaces 418 and may route the aggregated traffic to the configurable memory controller 208 for memory access operations. The main interconnect 804 may implement arbitration among traffic received from the multiple NoC interfaces 418, thereby determining the order in which transactions from different traffic generator groups may access the configurable memory controller 208.

The hierarchical arrangement of the system architecture 800 may introduce multiple levels of arbitration and buffering between the traffic generators and the configurable memory controller 208. Traffic generated by TG(1) through TG(N) may traverse the first NoC interface 418 before reaching the main interconnect 804. Traffic generated by TG′(1) through TG′(M) may traverse the second NoC interface 418 before reaching the main interconnect 804. At each hierarchical level, arbitration decisions and buffer availability may influence the transaction acceptance patterns and transaction response latencies for the individual traffic generators. The transactional-intelligence circuit 408 in each traffic generator may adapt transaction parameters based on the transaction acceptance patterns and transaction response latencies observed through the hierarchical backbone.

The DRAM interface 802 may handle asynchronous operations between the configurable memory controller 208 and the DRAM memory 306. The DRAM interface 802 may receive memory access commands from the configurable memory controller 208 and may translate the commands into DRAM-specific signaling for the DRAM memory 306. The asynchronous operations may accommodate timing differences between the system clock domain of the main interconnect 804 and the memory clock domain of the DRAM memory 306. The DRAM interface 802 may manage command queuing, data buffering, and timing compliance for memory operations directed to the DRAM memory 306.

The DRAM memory 306 may be organized into multiple pages including Page 0 and Page 1, with multiple banks extending to Bank n. The multi-bank organization may enable concurrent access to different banks by transactions from different traffic generators, subject to bank conflict avoidance and timing constraints enforced by the configurable memory controller 208. The configurable memory controller 208 may schedule memory access operations from the multiple traffic generators to maximize memory bandwidth utilization while respecting DRAM timing requirements.

The traffic generators TG(1) through TG(N) and TG′(1) through TG′(M) may communicate with the configurable memory controller 208 via the hierarchical backbone formed by the NoC interfaces 418 and the main interconnect 804. The hierarchical backbone may enable multiple traffic generators to share access to the configurable memory controller 208 and the DRAM memory 306 while maintaining isolation between traffic generator groups at the NoC-interface level. Each traffic generator may operate with the self-configurable adaptation capabilities described herein, and may adjust transaction parameters based on the transaction acceptance patterns and response-rate patterns observed through the hierarchical backbone.

The integration of multiple traffic generators with the hierarchical NoC/SoC backbone architecture may enable validation of complex SoC designs, in which numerous processing engines and memory clients may compete for shared memory bandwidth. The traffic generators TG(1) through TG(N) may replicate traffic patterns associated with a first functional domain of the SoC, and the traffic generators TG′(1) through TG′(M) may replicate traffic patterns associated with a second functional domain of the SoC. The hierarchical backbone may route traffic from the multiple functional domains through the main interconnect 804 to the configurable memory controller 208, thereby enabling validation of memory subsystem behavior under realistic multi-domain traffic conditions. The adaptive weight computation in each traffic generator may enable achievement of target bandwidth specifications despite contention introduced by traffic generated by other traffic generators communicating via the same hierarchical backbone.

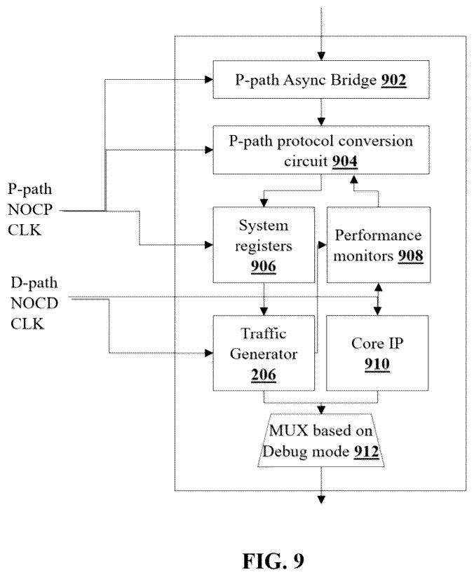

FIG. 9 is a block diagram of the self-configurable traffic generator system 400 integrated in a block design for pre-silicon validation and post-silicon debug applications, in accordance with an embodiment of the disclosure. The self-configurable traffic generator system 400 may receive two clock signals, e.g., a P-path Network-On-Chip Programming Path clock (NOCP CLK) and a D-path Network-on-Chip Data Path Clock (NOCD CLK), which are supplied to the block through external clock source on the SoC. The self-configurable traffic generator system 400 may be configured for integration in a pre-silicon validation environment and a post-silicon debug environment, thereby enabling use of the self-configurable traffic generator system 400 across different stages of the SoC development lifecycle.

The self-configurable traffic generator system 400 may include a P-path asynchronous bridge 902 that receives incoming signals and may perform asynchronous clock domain crossing. The P-path asynchronous bridge 902 accommodates timing differences between the external clock domains and the internal clock domains of the self-configurable traffic generator system 400. The P-path asynchronous bridge 902 may synchronize signals crossing between the NOCP clock domain and the internal processing clock domain, thereby preventing metastability and ensuring reliable data transfer across clock boundaries.

The P-path asynchronous bridge 902 may be connected to a P-path protocol conversion circuit 904, which performs protocol translation for incoming transactions. The P-path protocol conversion circuit 904 may convert transaction formats between the external bus protocol used by the NoC interface 418 and the internal protocol used in the self-configurable traffic generator system 400. The P-path protocol conversion circuit 904 may handle address mapping, data width conversion, and control signal translation to ensure compatibility between the external interface and the internal components of the self-configurable traffic generator system 400.

The P-path protocol conversion circuit 904 may interface with system registers 906 and performance monitors 908. The system registers 906 may store configuration parameters and control settings associated with the self-configurable traffic generator system 400. The system registers 906 may receive configuration data through the P-path protocol conversion circuit 904 and may provide the configuration parameters to internal components of the self-configurable traffic generator system 400 including the SFR circuit 402, the time-microscale circuit 404, and the transactional-intelligence circuit 408. The system registers 906 may enable software-accessible configuration of the self-configurable traffic generator system 400 during initialization and may provide readable status information to external components.

The performance monitors 908 may capture traffic information and performance statistics in a silicon-compatible format. The performance monitors 908 may track bandwidth achieved, transaction counts, latency measurements, and other performance metrics associated with traffic generated by the self-configurable traffic generator system 400. The performance monitors 908 may interface with the P-path protocol conversion circuit 904 to provide captured statistics to external monitoring components. The silicon-compatible format of the captured traffic information may enable direct comparison between traffic generator statistics and measurements obtained from actual silicon operation, thereby facilitating correlation between pre-silicon validation results and post-silicon debug observations.

The system registers 906 may be connected to the self-configurable traffic generator system 400 and to a core intellectual property (IP) block 910. The core IP block 910 may represent an intellectual property block that generates traffic in a production environment. The core IP block 910 may implement the actual functional logic that the self-configurable traffic generator system 400 may emulate during validation and debug operations. In a production configuration, the core IP block 910 may generate traffic based on the functional requirements of the SoC application. In a validation or debug configuration, the self-configurable traffic generator system 400 may generate traffic that replicates or stresses the traffic patterns associated with the core IP block 910.

Both the self-configurable traffic generator system 400 and the core IP block 910 may provide outputs to a debug-mode Multiplexer (MUX) 912. The debug-mode MUX 912 may select between traffic generated by the transmit generation core circuit and traffic from the core IP block 910. The debug-mode MUX 912 may receive a debug-mode selection signal that determines which traffic source provides output to the Datapath interface. When the debug-mode selection signal indicates debug-mode, the debug-mode MUX 912 may select the output from the self-configurable traffic generator system 400. When the debug-mode selection signal indicates normal operation mode, the debug-mode MUX 912 may select the output from the core IP block 910.

The output of the debug-mode MUX 912 may be connected to the datapath interface, thereby enabling the selected traffic source to provide transactions to the system backbone. The debug-mode MUX 912 may enable seamless switching between the self-configurable traffic generator system 400 and the core IP block 910 without requiring changes to the downstream datapath components. The datapath interface specifications may remain consistent regardless of whether the self-configurable traffic generator system 400 or the core IP block 910 provides the traffic, thereby enabling the traffic generator 206 to exercise the same datapath components that the core IP block 910 uses during normal operation.

The system architecture may include P-path and D-path clocks generated through a local clock management unit (CMU) at the block level. The local CMU may generate the internal processing clocks used by the self-configurable traffic generator system 400 and the core IP block 910 based on reference clock inputs. The P-path clock may control the protocol path components including the P-path asynchronous bridge 902 and the P-path protocol conversion circuit 904. The D-path clock may control the datapath components that handle transaction data transfer. The local CMU may provide clock generation, clock gating, and clock frequency adjustment capabilities for the block-level clocks.

The NOCD and NOCP clocks may be supplied externally from the SoC. The NOCD clock may provide the clock reference for the D-path NoC interface, synchronizing data transfers between the self-configurable traffic generator system 400 and the NoC. The NOCP clock may provide the clock reference for the P-path NoC interface, synchronizing protocol and control signal transfers. The external supply of the NOCD and NOCP clocks may enable the self-configurable traffic generator system 400 to operate synchronously with the NoC timing, thereby ensuring proper handshaking and data transfer across the NoC interface 418.

The debug-mode may be selected internally in the block to ensure the adaptive traffic generator issues traffic onto the bus and matches the datapath interface with the core IP block 910. The internal debug-mode selection may enable the self-configurable traffic generator system 400 to replace the core IP block 910 as the traffic source without external intervention during validation and debug operations. When debug-mode is selected, the self-configurable traffic generator system 400 may generate traffic that conforms to the same datapath interface specifications as the core IP block 910, thereby enabling the self-configurable traffic generator system 400 to exercise the downstream datapath components, the NoC, and the memory subsystem in the same manner as the core IP block 910.

The matching of the datapath interface between the self-configurable traffic generator system 400 and the core IP block 910 may ensure that transactions generated by the self-configurable traffic generator system 400 are indistinguishable from transactions generated by the core IP block 910 from the perspective of downstream components. The self-configurable traffic generator system 400 may generate transactions with the same address formats, data widths, burst characteristics, and sideband information as the core IP block 910. This interface matching may enable the self-configurable traffic generator system 400 to validate the behavior of the system interconnect 302, the configurable memory controller 208, and the DRAM memory 306 under traffic conditions that accurately represent the traffic patterns produced by the core IP block 910.

The integration of the self-configurable traffic generator system 400 in the block design may enable pre-silicon validation by allowing the self-configurable traffic generator system 400 to generate traffic in simulation and emulation environments before silicon fabrication. During pre-silicon validation, the self-configurable traffic generator system 400 may stress the system backbone with configurable traffic patterns, thereby enabling validation engineers to identify performance bottlenecks, to verify bandwidth capabilities, and to validate NoC architecture decisions. The adaptive weight computation in the self-configurable traffic generator system 400 may enable the self-configurable traffic generator system 400 to achieve target bandwidth specifications in pre-silicon environments, in which system behavior differs from post-silicon behavior due to simulation abstractions and timing approximations.

The integration may further enable post-silicon debug by allowing the self-configurable traffic generator system 400 to recreate traffic patterns observed during silicon operation. During post-silicon debug, the self-configurable traffic generator system 400 may replay traffic vectors extracted from silicon measurements, thereby enabling debug engineers to reproduce performance issues and backbone architecture problems observed in silicon. The debug-mode MUX 912 may enable switching between the core IP block 910 and the self-configurable traffic generator system 400 in post-silicon environments, thereby allowing debug engineers to isolate whether observed issues originate from the core IP block 910 or from the system backbone. The silicon-compatible format of the traffic information captured by the performance monitors 908 may enable direct comparison between traffic generator behavior and silicon measurements, thereby facilitating root cause analysis of post-silicon performance issues.

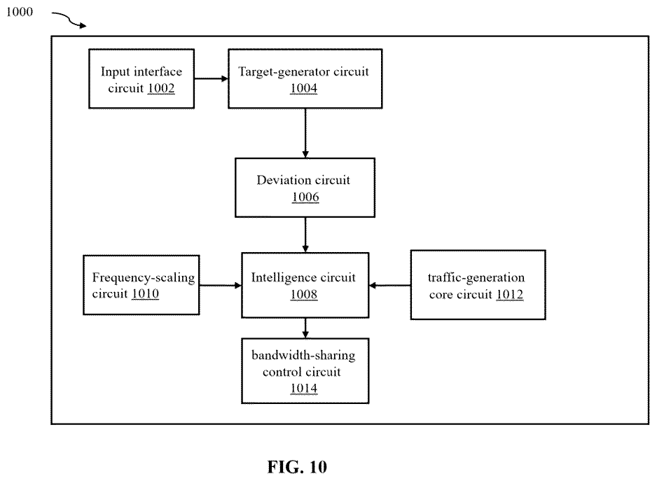

FIG. 10 is a block diagram of a traffic generator apparatus 1000 for validation of the SoC architecture, in accordance with an embodiment of the disclosure. For example, the traffic generator apparatus 1000 may include an input interface circuit 1002, a target-generator circuit 1004, a deviation circuit 1006, an intelligence circuit 1008, a traffic-generation core circuit 1010, and a frequency-scaling circuit 1012. The traffic generator apparatus 1000 may enable validation of SoC architectures through adaptive traffic generation that responds to real-time system behavior without external software intervention.

The input interface circuit 1002 may receive one or more configuration parameters including a timestamp-level bandwidth, a frequency, and latency information, from a silicon-dump or an external target specification source. The timestamp-level bandwidth may include bandwidth measurements associated with specific time instances, thereby enabling the traffic generator apparatus 1000 to replicate time-varying bandwidth patterns observed during silicon operation or specified by validation requirements. The frequency may include the operating frequency at which the traffic generator apparatus 1000 generates transactions, thereby establishing the baseline transaction-issue rate for traffic generation operations. The latency information may include response latency characteristics that inform the traffic generator apparatus 1000 about expected timing behavior of the system backbone.

The silicon-dump may provide configuration parameters extracted from measurements obtained during actual silicon operation. The silicon-dump may include recorded traffic patterns, bandwidth profiles, and timing information captured from silicon devices during execution of application workloads or validation scenarios. The input interface circuit 1002 may receive the configuration parameters from the silicon-dump and may provide the parameters to downstream circuits in the traffic generator apparatus 1000, thereby enabling the traffic generator apparatus 1000 to replicate traffic patterns observed in silicon with high fidelity.

The target-generator circuit 1004 may be coupled to the input interface circuit 1002 and may generate micro-level bandwidth targets based on the one or more configuration parameters. The target-generator circuit 1004 may receive the timestamp-level bandwidth, frequency, and latency information from the input interface circuit 1002 and may process the received parameters to produce bandwidth targets at a granular temporal resolution. The micro-level bandwidth targets may represent bandwidth objectives for individual time intervals in an overall traffic generation scenario, thereby enabling the traffic generator apparatus 1000 to track and achieve bandwidth targets with fine temporal precision.

The target-generator circuit 1004 may divide macro-level bandwidth specifications received through the input interface circuit 1002 into micro-level bandwidth targets corresponding to granular time periods. For example, when the input interface circuit 1002 provides a target bandwidth of 10 gigabytes per second over a time scale of 100 microseconds, the target-generator circuit 1004 may generate micro-level bandwidth targets for each 1 microsecond interval, producing 100 individual bandwidth targets that collectively achieve the macro-level objective. The target-generator circuit 1004 may generate client-specific bandwidth targets when the traffic generator apparatus 1000 supports multiple logical clients, thereby producing separate micro-level bandwidth targets for each logical client based on the respective bandwidth requirements.

The deviation circuit 1006 may be coupled to the target-generator circuit 1004 and may monitor real-time system behavior including transaction acceptance patterns and response-rate patterns. The deviation circuit 1006 may receive signals from the system backbone that indicate the acceptance and response behavior of the interconnect infrastructure during traffic generation operations. The transaction acceptance patterns may reflect the rate at which the system backbone accepts transactions issued by the traffic generator apparatus 1000, thereby varying based on multi-master contention, priority scheduling, and buffer availability in the system interconnect. The response-rate patterns may reflect the rate at which the system backbone returns responses to outstanding transactions, thereby varying based on memory controller scheduling and memory timing constraints.

The deviation circuit 1006 may estimate a deviation between an achieved bandwidth and a corresponding micro-level bandwidth target on a per-logical-client basis. The deviation circuit 1006 may compare the actual bandwidth achieved by each logical client during a granular time period against the micro-level bandwidth target generated by the target-generator circuit 1004 for that logical client and that granular time period. The deviation estimation produces a quantitative measure of how far the current traffic generation performance deviates from the specified objectives for each logical client. For example, when a logical client may achieve 8 gigabytes per second against a micro-level bandwidth target of 10 gigabytes per second, the deviation circuit 1006 may estimate a deviation of 2 gigabytes per second or 20 percent for that logical client.

The deviation circuit 1006 may compute adaptive weights using an adaptive learning technique. The adaptive learning technique may use data-driven parameter calculation that processes observed system behavior to generate weights reflecting the relationship between target bandwidth specifications and achieved bandwidth for each logical client. The deviation circuit 1006 may compute the adaptive weights based on the observed estimated deviation, the observed transaction acceptance patterns, and the observed response-rate patterns for each logical client. The adaptive weights enable the traffic generator apparatus 1000 to adjust traffic generation behavior in response to real-time system conditions.

The intelligence circuit 1008 may be coupled to the deviation circuit 1006 and may receive the adaptive weights computed by the deviation circuit 1006. The intelligence circuit 1008 may process the received adaptive weights to determine adjustments to traffic generation parameters that compensate for observed deviations and system behavior variations. The intelligence circuit 1008 may operate on a per-logical-client basis, thereby receiving separate adaptive weights for each logical client and computing corresponding parameter adjustments for each logical client.

The intelligence circuit 1008 may control degrees of freedom including intra-transaction parameters, a transaction-issue rate, and inter-transaction parameters based on the adaptive weights. The intra-transaction parameters may include transaction size, burst specifications, and length parameters that determine the data transfer characteristics of individual transactions. The transaction-issue rate may include the frequency at which the traffic generator apparatus 1000 issues transactions to the system backbone. The inter-transaction parameters may include a maximum outstanding transaction count and issue-traffic patterns that determine the relationship between consecutive transactions and the overall traffic flow pattern.

The intelligence circuit 1008 may control the intra-transaction parameters by adjusting transaction size to modify the data payload per transaction, thereby adjusting burst specifications to modify the burst characteristics of transactions, and adjusting length parameters to modify the number of data beats per burst transaction. When the adaptive weights indicate that a logical client requires increased bandwidth, the intelligence circuit 1008 may increase the intra-transaction parameters to transfer more data per transaction.

The intelligence circuit 1008 may control the transaction-issue rate by requesting frequency adjustments through the frequency-scaling circuit 1012 when adjustment of other parameters proves insufficient to achieve bandwidth targets. The transaction-issue rate may affect the number of transactions issued per unit time, with higher transaction-issue rates enabling higher potential bandwidth achievement.

The intelligence circuit 1008 may control the inter-transaction parameters by adjusting the maximum outstanding transaction count to modify the depth of the transaction pipeline and adjusting issue-traffic patterns to modify the temporal distribution of transaction issuance. When the adaptive weights indicate that a logical client experiences high response latencies, the intelligence circuit 1008 may increase the maximum outstanding transaction count to maintain sufficient pending transactions despite increased response times.

The intelligence circuit 1008 may output modified transaction parameters for traffic generation. The modified transaction parameters may include the adjusted intra-transaction parameters, the adjusted transaction-issue rate, and the adjusted inter-transaction parameters computed by the intelligence circuit 1008 based on the adaptive weights. The intelligence circuit 1008 may provide the modified transaction parameters to the traffic-generation core circuit 1010 for use in generating traffic according to the adjusted specifications.

The traffic-generation core circuit 1010 may be coupled to the intelligence circuit 1008 and may generate traffic based on the modified transaction parameters. The traffic-generation core circuit 1010 may receive the modified transaction parameters from the intelligence circuit 1008 and may generate actual traffic transactions according to the specified transaction size, burst specifications, length parameters, and issue-traffic patterns. The traffic-generation core circuit 1010 may issue transactions to the system backbone at the transaction-issue rate specified by the modified transaction parameters, thereby generating traffic that may represent the traffic patterns associated with logical clients being emulated by the traffic generator apparatus 1000.

The traffic-generation core circuit 1010 may support multiple logical clients, and may generate traffic for each logical client according to the respective modified transaction parameters received from the intelligence circuit 1008. The traffic-generation core circuit 1010 may implement arbitration among the logical clients based on the adaptive weights, and may allocate transaction opportunities to the logical clients in proportion to the respective adaptive weights. The traffic-generation core circuit 1010 may format transactions according to the bus protocol requirements of the system backbone and may transmit the formatted transactions through the interconnect interface.

The frequency-scaling circuit 1012 may be coupled to the intelligence circuit 1008 and may adjust a transaction frequency received based on feedback from the intelligence circuit. The frequency-scaling circuit 1012 may receive frequency-change requests from the intelligence circuit 1008 when the intelligence circuit 1008 determines that adjustment of intra-transaction parameters and inter-transaction parameters is insufficient to achieve bandwidth targets. The frequency-scaling circuit 1012 may process the frequency-change requests and may implement frequency adjustments that modify the transaction-issue rate of the traffic generator apparatus 1000.

The frequency-scaling circuit 1012 may adjust the transaction frequency by modifying the clock rate at which the traffic-generation core circuit 1010 operates. When the intelligence circuit 1008 requests an increase in transaction frequency, the frequency-scaling circuit 1012 may increase the clock rate, thereby enabling the traffic-generation core circuit 1010 to issue transactions at a higher rate. When the intelligence circuit 1008 requests a decrease in transaction frequency, the frequency-scaling circuit 1012 may decrease the clock rate, thereby reducing the transaction-issue rate. The frequency-scaling circuit 1012 may provide frequency-change acknowledgments to the intelligence circuit 1008 upon completion of frequency adjustments, thereby enabling the intelligence circuit 1008 to incorporate the modified frequency into subsequent parameter calculations.

The feedback from the intelligence circuit 1008 to the frequency-scaling circuit 1012 may include frequency-change requests generated when the intelligence circuit 1008 exhausts the available range of parameter adjustments without achieving target bandwidth specifications. The intelligence circuit 1008 may monitor the effectiveness of parameter adjustments applied during successive measurement intervals and may determine whether the adjusted parameters result in achieved bandwidth that satisfies the target bandwidth. When the intelligence circuit 1008 determines that parameter adjustment alone is insufficient, the intelligence circuit 1008 may generate a frequency-change request directed to the frequency-scaling circuit 1012.

The intelligence circuit 1008 may operate on a per-logical-client basis, and may receive inputs including a transaction acceptance rate, a transaction response rate, a target-deviation value, a current transaction frequency, an average transaction length, an average transaction size, and a stream-and-blank rate for each logical client. The transaction acceptance rate may represent the ratio of accepted transactions to issued transactions for the logical client over a measurement interval. The transaction response rate may represent the rate at which the system backbone returns responses to outstanding transactions for the logical client. The target-deviation value may represent the difference between a target bandwidth and an achieved bandwidth for the logical client. The current transaction frequency may represent the operating frequency at which the traffic generator apparatus 1000 issues transactions. The average transaction length may represent the average number of data beats per transaction for the logical client. The average transaction size may represent the average data payload size per transaction for the logical client. The stream-and-blank rate may represent the ratio of active transaction streaming periods to idle periods in the traffic pattern for the logical client.

The per-logical-client operation may enable the intelligence circuit 1008 to compute individualized parameter adjustments that account for the distinct system conditions and bandwidth requirements experienced by each logical client during traffic generation operations. The per-logical-client operation of the intelligence circuit 1008 may enable the traffic generator apparatus 1000 to manage multiple logical clients with differing bandwidth requirements and system conditions. Each logical client may receive individually computed output parameters based on the input parameters observed for that logical client, thereby enabling tailored parameter adjustments that account for the specific conditions experienced by each logical client. For example, when logical client A experiences a transaction acceptance rate of 90 percent and logical client B experiences a transaction acceptance rate of 60 percent, the intelligence circuit 1008 may compute different output parameters for each logical client, with logical client B receiving parameter adjustments that compensate for the lower acceptance rate.

The intelligence circuit 1008 may perform the input processing and output generation continuously during traffic generation, and may update the output parameters for each logical client based on the input parameters observed during successive measurement intervals. The continuous operation may enable the intelligence circuit 1008 to track and respond to dynamic variations in system behavior, and may adjust the output parameters for each logical client in response to changing transaction acceptance rates, transaction response rates, and target-deviation values. The per-logical-client output parameters may flow to the traffic-generation core circuit 1010, in which the parameters control traffic generation behavior for each logical client according to the computed adjustments.

The intelligence circuit 1008 may output, for each logical client, an updated average transaction length, an updated average transaction size, a modified transaction frequency, a modified stream-and-blank rate, and a client weight for a slot-machine adaptor. The updated average transaction length may represent an adjusted transaction length value computed by the intelligence circuit 1008 based on the observed system behavior and bandwidth deviation. The updated average transaction size may represent an adjusted transaction size value computed to improve bandwidth achievement. The modified transaction frequency may represent an adjusted operating frequency value when frequency scaling is applied. The modified stream-and-blank rate may represent an adjusted ratio of streaming to idle periods in the traffic pattern. The client weight for the slot-machine adaptor may represent the adaptive weight computed for the logical client that influences arbitration decisions in the traffic-generation core circuit 1010.

The traffic generator apparatus 1000 may achieve target bandwidths in a non-deterministic system by closed-loop adaptation of the modified transaction parameters. The closed-loop adaptation may operate by monitoring system behavior through the deviation circuit 1006, computing adaptive weights based on the observed behavior, controlling transaction parameters through the intelligence circuit 1008 based on the adaptive weights, generating traffic through the traffic-generation core circuit 1010 based on the controlled parameters, and repeating the monitoring and computation cycle during subsequent measurement intervals. The closed-loop adaptation may enable the traffic generator apparatus 1000 to respond to dynamic changes in system behavior without external intervention, thereby maintaining target bandwidth achievement despite non-deterministic variations in transaction acceptance patterns and response-rate patterns.

The traffic-generation core circuit 1010 may include a bandwidth-sharing control circuit 1014 that controls bandwidth allocation among a plurality of logical clients. The bandwidth-sharing control circuit 1014 may receive per-client weights from the intelligence circuit 1008 and may distribute available bandwidth among the logical clients according to the received weights. For example, when a logical client receives a higher weight, the bandwidth-sharing control circuit 1014 may allocate a proportionally greater share of the available bandwidth to that logical client.

The traffic-generation core circuit 1010 may further include a bus-communication packet engine that generates packets conforming to a bus protocol. The bus-communication packet engine may receive transaction parameters from the intelligence circuit 1008 and may construct packets according to the protocol requirements of the system backbone. The bus-communication packet engine may format transaction addresses, data payloads, and control information into packet structures suitable for transmission through the interconnect infrastructure.

The traffic generator apparatus 1000 may further include a client-wise outstanding counter that tracks a number of outstanding transactions for each logical client. The client-wise outstanding counter may maintain a separate count for each logical client, incrementing the count when a transaction is issued for that logical client and decrementing the count when a response is received for that logical client. The client-wise outstanding counter may provide the outstanding transaction count for each logical client to the intelligence circuit 1008, thereby enabling the intelligence circuit 1008 to enforce maximum outstanding transaction limits on a per-logical-client basis.

As an example of client-wise outstanding transaction tracking, a traffic generator apparatus 1000 may be configured with three logical clients designated as Client X, Client Y, and Client Z. Client X may operate with a maximum outstanding capability of 12 transactions, Client Y may operate with a maximum outstanding capability of 8 transactions, and Client Z may operate with a maximum outstanding capability of 16 transactions. During traffic generation, the client-wise outstanding counter may maintain three separate count registers tracking the outstanding transactions for each logical client.

At a certain time instant, Client X may have 10 outstanding transactions for which responses have not yet been received, resulting in an outstanding count of 10 for Client X. Client Y may have 8 outstanding transactions for which responses have not yet been received, resulting in an outstanding count of 8 for Client Y. Client Z may have 14 outstanding transactions for which responses have not yet been received, resulting in an outstanding count of 14 for Client Z.

The client-wise outstanding counter may provide these count values to the intelligence circuit 1008. For Client X, the outstanding count of 10 may be below the maximum of 12, so Client X may be permitted to issue additional transactions. For Client Y, the outstanding count of 8 may equal the maximum of 8, so Client Y may be blocked from issuing additional transactions until a response is received. For Client Z, the outstanding count of 14 may be below the maximum of 16, so Client Z may be permitted to issue additional transactions.

When the system backbone returns a response for a transaction previously issued by Client Y, the client-wise outstanding counter decrements the count for Client Y from 8 to 7. The updated count of 7 may be below the maximum of 8, so Client Y may be now permitted to issue additional transactions. The client-wise outstanding counter may provide the updated count to the intelligence circuit 1008, which enables transaction issuance for Client Y to resume.

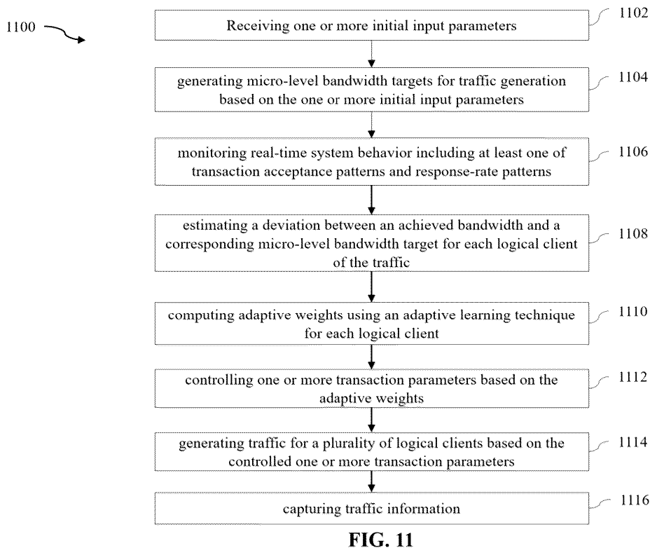

FIG. 11 is a flowchart for a method for adaptive traffic generation in the SoC architecture, in accordance with an embodiment of the disclosure.

For example, at step 1102, the method 1100 may include receiving, by the SFR circuit 402 the one or more initial input parameters. The one or more initial input parameters may include the at least one of a frequency, the expected bandwidth, the periodicity, and the latency from the silicon-dump or the external target specification. The silicon-dump may provide timestamp-level bandwidth, frequency, and latency information extracted from existing silicon measurements, thereby enabling the traffic generators 206 to operate in a replay mode, in which traffic patterns observed in actual silicon operation are replicated. The external target specification may provide bandwidth and frequency targets defined by a user or validation environment for scenarios, in which silicon-dump data is unavailable or in which specific target conditions are to be validated.

The method 1100 may proceed to step 1104, in which micro-level bandwidth targets for traffic generation are generated based on the one or more initial input parameters. Accordingly, at step 1104, the method 1100 may include generating, by the time-microscale circuit 404, the micro-level bandwidth targets. The time-microscale circuit 404 may divide macro-level bandwidth targets into granular time periods, generating client-specific bandwidth targets for each granular time period.

The method 1100 may continue to step 1106, in which real-time system behavior is monitored. At step 1106, the method 1100 may include monitoring, by the target-deviation circuit 406, real-time system behavior including at least one of transaction acceptance patterns and response-rate patterns.

The method 1100 may move to step 1108, where the deviation between an achieved bandwidth and a corresponding micro-level bandwidth target is estimated for each logical client of the traffic. At step 1108, the method 1100 may include estimating, by the target-deviation circuit 406, the deviation between the achieved bandwidth and the corresponding micro-level bandwidth target by comparing the actual bandwidth achieved by each logical client during a granular time period against the micro-level bandwidth target generated for that logical client and that granular time period. For example, the target-deviation circuit 406 may calculate the deviation as a difference or ratio between the target bandwidth and the achieved bandwidth, thereby providing a quantitative measure of how far the current traffic generation performance deviates from the specified objectives for each logical client.

Then, at step 1110, the method 1100 may include computing, by the target-deviation circuit 406, adaptive weights using the adaptive learning technique for each logical client. The adaptive learning technique may use data-driven parameter calculation responsive to configuration conditions and may generate adaptive weights that reflect the relationship between target bandwidth specifications and achieved bandwidth for each logical client. The target-deviation circuit 406 may output separate adaptive weights for each logical client, with the weight values reflecting the adjustments computed to compensate for the observed system behavior and bandwidth deviation experienced by each logical client.

Then, at step 1112, the method 1100 may include controlling, by the transactional-intelligence circuit 408, the one or more transaction parameters based on the adaptive weights controls. The one or more transaction parameters may include the at least one of a transaction size, the burst specifications, the length parameters, the frequency scaling, the number of outstanding transactions, and the issue-traffic patterns. The transactional-intelligence circuit 408 may receive the adaptive weights from the target-deviation circuit 406 and may adjust the one or more transaction parameters to increase or decrease the achieved bandwidth toward the target bandwidth for each logical client. The transactional-intelligence circuit 408 may modify intra-transaction parameters including transaction size, burst specifications, and length parameters to change the data transfer efficiency of individual transactions. The transactional-intelligence circuit 408 may modify inter-transaction parameters including the number of outstanding transactions and issue-traffic patterns to change the relationship between consecutive transactions and the overall traffic flow pattern. The transactional-intelligence circuit 408 may request frequency scaling adjustments through the transmit DVFS circuit 414 when adjustment of the intra-transaction parameters and inter-transaction parameters is insufficient to satisfy bandwidth targets.

Then, at step 1114, the method 1100 may include generating, by the transmit generation core circuit 410, traffic for the plurality of clients based on the controlled one or more transaction parameters. The transmit generation core circuit 410 may receive the modified transaction parameters from the transactional-intelligence circuit 408 and may generate actual traffic transactions with the specified transaction size, burst specifications, length parameters, and issue-traffic patterns. The transmit generation core circuit 410 may issue transactions to the system backbone through the NoC interface 418, with the generated traffic representing the traffic patterns of the plurality of clients being emulated by the traffic generators 206.

Thereafter, at step 1116, the method 1100 may include capturing, by the performance monitor circuit 412, the traffic information. The performance monitor circuit 412 may capture traffic information in a silicon-compatible format, including achieved bandwidth, transaction counts, latency measurements, and other performance metrics for traffic generated by the traffic generators 206. The captured traffic information may be provided to the target-deviation circuit 406 for use in subsequent iterations of the adaptive weight computation, thereby enabling closed-loop adaptation of transaction parameters based on observed traffic generation performance.

The method 1100 may operate iteratively, with the steps 1106 through 1116 repeating continuously during traffic generation. After the step 1116 captures traffic information, the method 1100 returns to the step 1106 to monitor real-time system behavior for the next measurement interval. The target-deviation circuit 406 may estimate deviation for the next granular time period in the step 1108, may compute updated adaptive weights in the step 1110, and the transactional-intelligence circuit 408 may control the one or more transaction parameters based on the updated weights in the step 1112. This iterative operation may enable the traffic generators 206 to continuously adapt to changing system conditions and to track bandwidth targets that vary across the granular time periods (t/N) in the overall time period (t).

In some embodiments, a system may comprise a transaction-address request first-in-first-out (FIFO) buffer and a response FIFO buffer. The arbiter may control push operations for the transaction-address request FIFO buffer and pop operations for the response FIFO buffer.

In some embodiments, the transmit generation core circuit may comprise a dynamic traffic controller, an input/output interface, and a slot-machine adaptor with quality of service (QoS) controller to receive per-client weights from the transactional-intelligence circuit.

In some embodiments, the transactional-intelligence circuit may output, for each logical client, an updated average transaction length, an updated average transaction size, a modified transaction frequency, a modified stream-and-blank rate, and a client weight for the slot-machine adaptor.

In some embodiments, the system may be integrated in a pre-silicon validation environment and a post-silicon debug environment.

In some embodiments, the system may comprise a debug-mode multiplexer to select between traffic generated by the transmit generation core circuit and traffic from a core intellectual-property block.

In some embodiments, the method may comprise, based on determining that adjustment of the intra-transaction parameters and the inter-transaction parameters is insufficient to satisfy bandwidth targets, transmitting a frequency-change request to a transmit dynamic voltage and frequency scaling (DVFS) circuit and adjusting a transaction-issue rate based on a modified frequency.

In some embodiments, the computing of the adaptive weights may comprise monitoring, per logical client, a transaction acceptance rate and a transaction response rate, calculating a target-deviation value based on a difference between a target bandwidth and an achieved bandwidth, and generating arbitration weights based on the monitored transaction acceptance rate, the transaction response rate, and the calculated target-deviation value.

In some embodiments, the method may comprise arbitrating, by an arbiter in the transactional-intelligence circuit, among a plurality of logical clients based on the adaptive weights and issuing transactions from the plurality of logical clients based on an arbitration result.

In some embodiments, the method may comprise estimating, by the target-deviation circuit, a maximum achievable bandwidth based on a target bandwidth being unachievable due to system constraints and outputting the maximum achievable bandwidth to the transactional-intelligence circuit.

In some embodiments, the intelligence circuit may operate on a per-logical-client basis receiving inputs comprising a transaction acceptance rate, a transaction response rate, a target-deviation value, a current transaction frequency, an average transaction length, an average transaction size, and a stream-and-blank rate.

In some embodiments, the traffic-generation core circuit may comprise a bandwidth-sharing control circuit to control bandwidth allocation among a plurality of logical clients and a bus-communication packet engine to generate packets conforming to a bus protocol.

In some embodiments, the traffic generator apparatus may comprise a client-wise outstanding counter to track a number of outstanding transactions for each logical client and client-wise statistics monitors to capture traffic statistics for each logical client.

The disclosure may provide several significant advantages in accurately recreating and analyzing silicon behavior of SoC. The system may enable the recreation of real silicon behavior by utilizing actual silicon-dump data, thereby reproducing performance-related issues in simulation or emulation environments without relying on physical silicon. Thus, the system substantially may reduce the need for repeated silicon fabrication cycles, thereby helping hardware teams identify root causes of issues, validate software fixes, and verify solutions early in the development flow. Accordingly, the system may lower development time and fabrication costs. For example, the configurable memory controller may allow independent control of memory access latencies for each master, thereby enabling precise replication of timing conditions that contribute to silicon performance issues. The system may further provide independent handling of read and write transactions for each master, thereby improving the fidelity of recreated latency characteristics based on observations from actual silicon. Through the integrated traffic generators, the system may inject realistic transaction patterns and bandwidth characteristics into the NoC, thereby ensuring that behavior seen in real silicon is accurately reproduced. Furthermore, the system may support architectural validation for future SoC designs by allowing evaluation of bus architecture changes, buffer depth variations, and memory organization decisions before fabrication, thereby reducing architectural risks. Further, the adaptive traffic generation may respond to dynamic system behavior and backpressure conditions, thereby ensuring that traffic patterns remain realistic and representative of true silicon operation.

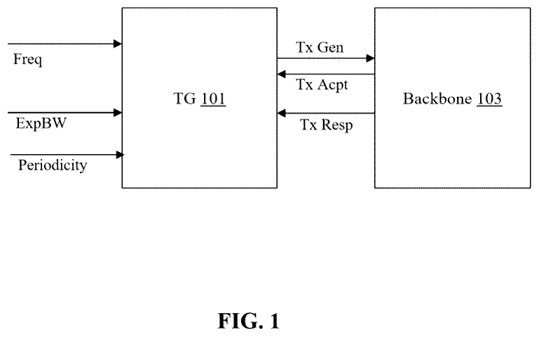

At least one of the components, elements, modules, units, or the like (collectively “components” in this paragraph) represented by a block or an equivalent indication (collectively “block”) in the above embodiments including the drawings, for example, FIGS. 1 through 10, may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories to perform the functions or operations described herein. These components may, for example, be embodied in one or more semiconductor chips, or on substrate supports such as printed circuit boards and the like. These circuits may also be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks. While specific language is used to describe the disclosure, any limitations arising on account of the same are not intended. As would be apparent to a person in the art, various working modifications may be made to the method in order to implement the inventive concept as taught herein.

The drawings and the forgoing description give examples of embodiments. It will be understood that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

1. A self-configurable traffic generator system in a System-on-Chip (SoC) architecture, comprising:
a transmit special function register (SFR) circuit configured to receive one or more initial input parameters, the one or more initial input parameters comprising at least one of a frequency, an expected bandwidth, a periodicity, and a latency from at least one of a silicon-dump and an external target specification;
a time-microscale circuit configured to generate micro-level bandwidth targets for traffic generation based on the one or more initial input parameters;
a target-deviation circuit coupled to the time-microscale circuit and configured to:
estimate, for each logical client, a deviation between an achieved bandwidth and a corresponding micro-level bandwidth target; and
compute, for each logical client, adaptive weights using an adaptive learning technique;
a transactional-intelligence circuit coupled to the target-deviation circuit and configured to control one or more transaction parameters comprising at least one of a transaction size, burst specifications, length parameters, a transaction-issue rate with frequency scaling, a number of outstanding transactions, and issue-traffic patterns, based on the adaptive weights;
a transmit generation core circuit configured to generate traffic for a plurality of logical clients based on the controlled one or more transaction parameters; and
a performance monitor circuit configured to capture traffic information.

2. The system of claim 1, wherein the transactional-intelligence circuit is configured to control three degrees of freedom comprising:
intra-transaction parameters comprising size, burst, and length;
inter-transaction parameters comprising a maximum outstanding capability and an issue-traffic pattern; and
frequency scaling.

3. The system of claim 1, further comprising a transmit dynamic voltage and frequency scaling (DVFS) circuit coupled to the transactional-intelligence circuit and configured to adjust an operating frequency based on a frequency-change request based on adjustment of the transaction parameters being insufficient to satisfy bandwidth targets.

4. The system of claim 1, wherein the target-deviation circuit is configured to compute the adaptive weights per logical client based on a transaction acceptance rate, a transaction response rate, and a target-deviation rate indicative of a difference between a target bandwidth and the achieved bandwidth.

5. The system of claim 1, wherein the transactional-intelligence circuit comprises an arbiter configured to allocate bandwidth among a configurable number of logical clients based on the adaptive weights.

6. (canceled)

7. The system of claim 1, wherein the transactional-intelligence circuit is configured to adjust the transaction parameters based on non-deterministic system behavior caused by at least one of: multi-master contention on a system interconnect, priority among masters, buffer depths in a network-on-chip backbone, and transient traffic conditions.

8. The system of claim 1, wherein the transactional-intelligence circuit is configured to adjust the transaction parameters based on response-rate variations caused by memory-controller scheduling and intrinsic dynamic random access memory (DRAM) timing requirements comprising self-refresh, read-to-write, read-to-read, and write-to-write timing constraints.

9. (canceled)

10. The system of claim 1, wherein the transactional-intelligence circuit is configured to compute, for each logical client, an output as a function of a target-deviation value, a target bandwidth value, a current operating frequency, a transaction acceptance-rate value, a response-rate value, a stream-rate value, an average transaction length, and an average transaction size.

11-13. (canceled)

14. The system of claim 1, wherein the target-deviation circuit is configured to estimate a maximum effort for closest achievable bandwidth based on a target bandwidth being unachievable due to system constraints.

15. The system of claim 1, further comprising a client-wise outstanding counter configured to track outstanding transactions per logical client and to determine whether a number of outstanding transactions is less than a maximum outstanding capability before issuing new transactions.

16. The system of claim 1, wherein the performance monitor circuit comprises client-wise statistics monitors configured to capture per-client traffic statistics to be used by the target-deviation circuit.

17. A method for adaptive traffic generation in a System-on-Chip (SoC) architecture, comprising:
receiving, by a transmit special function register (SFR) circuit, one or more initial input parameters, the one or more initial input parameters comprising at least one of a frequency, an expected bandwidth, a periodicity, and a latency from a silicon-dump or an external target specification;
generating, by a time-microscale circuit, micro-level bandwidth targets for traffic generation based on the one or more initial input parameters;
monitoring, by a target-deviation circuit, real-time system behavior comprising at least one of transaction acceptance patterns and response-rate patterns;
estimating, by the target-deviation circuit, a deviation between an achieved bandwidth and a corresponding micro-level bandwidth target for each logical client of the traffic;
computing, by the target-deviation circuit, adaptive weights using an adaptive learning technique for each logical client;
controlling, by a transactional-intelligence circuit, one or more transaction parameters comprising at least one of a transaction size, burst specifications, length parameters, frequency scaling, a number of outstanding transactions, and issue-traffic patterns, based on the adaptive weights;
generating, by a transmit generation core circuit, traffic for a plurality of logical clients based on the controlled one or more transaction parameters; and
capturing, by a performance monitor circuit, traffic information.

18. The method of claim 17, further comprising determining, by the transactional-intelligence circuit, whether transaction acceptance ratios satisfy reference criteria and, based on determining that the reference criteria are not satisfied, adjusting at least one of intra-transaction parameters and inter-transaction parameters.

19-20. (canceled)

21. The method of claim 17, wherein the controlling of the transaction parameters comprises dynamically adjusting an average transaction length, an average transaction size, a stream-and-blank rate, a maximum number of outstanding transactions, and a transaction-issue frequency.

22. The method of claim 17, further comprising receiving, by the transmit generation core circuit, transaction acceptance signals and transaction response signals from a system backbone and adapting, by the transactional-intelligence circuit, traffic generation based on the received transaction acceptance signals and transaction response signals.

23. The method of claim 17, wherein the generating of the micro-level bandwidth targets comprises dividing a target bandwidth over a time scale into granular time periods to generate client-specific bandwidth targets for each granular time period.

24-25. (canceled)

26. The method of claim 17, wherein the adaptive learning technique comprises data-driven parameter calculation based on configuration conditions and generation of the adaptive weights for the transmit generation core circuit based on the calculated parameters.

27. A traffic generator apparatus for validation of a System-on-Chip (SoC) architecture, comprising:
an input interface circuit configured to receive one or more configuration parameters comprising a timestamp-level bandwidth, a frequency, and latency information, from at least one of a silicon-dump and an external target specification source;
a target-generator circuit coupled to the input interface circuit and configured to generate micro-level bandwidth targets based on the one or more configuration parameters;
a deviation circuit coupled to the target-generator circuit and configured to:
monitor real-time system behavior comprising transaction acceptance patterns and response-rate patterns,
estimate a deviation between an achieved bandwidth and a corresponding micro-level bandwidth target on a per-logical-client basis, and
compute adaptive weights using an adaptive learning technique;
an intelligence circuit coupled to the deviation circuit and configured to:
receive the adaptive weights, control degrees of freedom comprising intra-transaction parameters, a transaction-issue rate, and inter-transaction parameters based on the adaptive weights, and
output modified transaction parameters for traffic generation;
a traffic-generation core circuit coupled to the intelligence circuit and configured to generate traffic based on the modified transaction parameters; and
a frequency-scaling circuit coupled to the intelligence circuit and configured to adjust a transaction frequency based on feedback from the intelligence circuit.

28. (canceled)

29. The traffic generator apparatus of claim 27, wherein the intelligence circuit is configured to output, for each logical client, an updated average transaction length, an updated average transaction size, a modified transaction frequency, a modified stream-and-blank rate, and a client weight for a slot-machine adaptor.

30. The traffic generator apparatus of claim 27, wherein the traffic generator apparatus is configured to perform closed-loop adaptation of the modified transaction parameters in a non-deterministic system.

31-32. (canceled)
